(19) United States
(12) Patent Application Publication
(10) Pub. No.: US 2012/0286759 A1
(43) Pub. Date: Nov. 15, 2012

(54) DISTRIBUTED POWER GENERATION SYSTEM

(76) Inventors: Akihito Ootani, Hyogo (JP); Hiroaki Kaku, Shiga (JP); Hiroshi Nagasato, Shiga (JP); Nin Kake, Nara (JP); Keiichi Sato, Kyoto (JP); Toru Kushisaka, Nara (JP)

(21) Appl. No.: 13/574,966

(22) PCT Filed: Jan. 31, 2011
(86) PCT No.: PCT/JP2011/000519

§ 371 Date: Jul. 24, 2012

(30) Foreign Application Priority Data
Feb. 1, 2010 (JP) 2010-020077

(51) Int. Cl. H02J 3/00

(52) U.S. Cl. 323/304

(57) ABSTRACT

A distributed power generation system of the present invention is a distributed power generation system connected to a three-wire electric power system including first to third electric wires, the third electric wire being a neutral wire, and includes: an electric power generator (105); a connection mechanism (110) configured to connect any two electric wires among the first to third electric wires (101a to 101c) to an internal electric power load (111); a first current sensor (109a) set so as to detect a current value of the first electric wire (101a); a second current sensor (109b) set so as to detect a current value of the second electric wire (101b); and an operation controller (112) configured to determine the electric wire on which each of the first current sensor (109a) and the second current sensor (109b) is provided and an installing direction of each of the first current sensor (109a) and the second current sensor (109b) by determining whether or not the amount of change in the current value detected by each of the first current sensor (109a) and the second current sensor (109b) before and after the connection mechanism (110) connects any two electric wires to the internal electric power load (111) is the amount corresponding to the power consumption of the internal electric power load (111).

### TECHNICAL FIELD

The present invention relates to a distributed power generation system configured to supply AC power to an electric power system and a home AC load in combination with the electric power system.

### BACKGROUND ART

One conventional example of this type of distributed power generation system is a system having the configuration shown in FIG. 9 (see PTL 1, for example). Hereinafter, the conventional distributed power generation system will be explained in reference to the drawing. FIG. 9 is a block diagram showing the schematic configuration of the distributed power generation system disclosed in PTL 1.

As shown in FIG. 9, the conventional distributed power generation system is constituted by a private electric power generator 1, a distribution board 2, a single-phase three-wire commercial electric power system 3 constituted by U, 0, and W phases, a calculation storage portion 7, and a display unit 10. Here, the private electric power generator 1 is connected to the commercial electric power system 3 and outputs generated electric power as AC power capable of performing reverse power flow. The distribution board 2 includes a branch disconnector 4, a current sensor CTa provided between the commercial electric power system 3 and the branch disconnector 4 to detect a current of the U phase, and a current sensor CTb provided between the commercial electric power system 3 and the branch disconnector 4 to detect a current of the W phase.

The calculation storage portion 7 calculates and stores electric power for selling and purchasing and includes an electric power calculating portion 8a, an electric power calculating portion 8b, an addition calculating portion 14, a non-volatile memory 15, and a sign determining portion 16. The electric power calculating portion 8a receives a current detection signal 6b from the current sensor CTb. In addition, the electric power calculating portion 8a receives a voltage detection signal 5 for detecting the voltage of the commercial electric power system 3 and calculates electric power based on current information from the current sensor CTb and voltage information. The electric power calculating portion 8b receives a current detection signal 6a from the current sensor CTa. In addition, the electric power calculating portion 8b receives the voltage detection signal 5 for detecting the voltage of the commercial electric power system 3 and calculates electric power based on the current information from the current sensor CTb and the voltage information. The addition calculating portion 14 receives calculation results from the electric power calculating portions 8a and 8b. The non-volatile memory 15 stores positive and negative signs of the addition calculating portion 14 and the electric power calculating portions 8a and 8b (in this conventional example, the reverse power flow corresponds to negative). The sign determining portion 16 receives an operating state and stop state of the private electric power generator 1.

After the conventional distributed power generation system configured as above is installed, the distributed power generation system causes respective electric power calculating units 8 (8a and 8b) to calculate the current detection signals 6 (6a and 6b) of the current sensors CTa and CTb when electric power generation information transmitted from the private electric power generator 1 to the sign determining portion 16 is a signal indicating a no communication data state (no electric power generation state) or an electric power generation stop state, by utilizing the fact that the reverse power flow (electric power selling) is never performed when the private electric power generator 1 is not generating the electric power.

In a case where each of absolute values of respective results of the above calculation is equal to or more than a predetermined value (for example, 0.1 kW or more) and, for example, the result of the electric power calculating portion 8a has the negative sign, it is determined that sign reversal of the electric power calculating portion 8a is occurring due to reverse attachment of the current sensor CTb. Therefore, the conventional distributed power generation system causes the non-volatile memory 15 of the sign determining portion 16 to store information that the sign needs to be inverted. After this, a correction request signal is output to the addition calculating portion 14 such that the negative sign is converted into the positive sign when the data of the negative sign is output from the electric power calculating portion 8a and the positive sign is converted into the negative sign when the data of the positive sign is output from the electric power calculating portion 8a. Thus, current-direction sign reversal due to the reverse attachment of the current sensor CTb is properly corrected. Similarly, the conventional distributed power generation system can deal with a case where the sign reversal of the electric power calculating portion 8b has occurred due to the reverse attachment of the current sensor CTa.

### CITATION LIST

### Patent Literature

PTL 1: Japanese Laid-Open Patent Application Publication No. 2004-297959

### SUMMARY OF INVENTION

### Technical Problem

However, the conventional configuration has problems that in a case where each of two current sensors CTa and CTb is attached to an improper phase at an interconnection point of the commercial electric power system 3 and the distributed power generation system during the installation or maintenance work, or failures or the like of two current sensors CTa and CTb have occurred, the current sensors CTa and CTb cannot properly measure the currents and improper electric power information is displayed on the display unit 10. In addition, further problems are that in the above case, determination of the amount of electric power generation based on received electric power when the private electric power generator 1 is generating electric power and control for preventing the reverse power flow cannot be normally performed.

The present invention was made to solve the above conventional problems, and an object of the present invention is to provide a distributed power generation system capable of determining, by a simple configuration, an electric wire on which a current sensor is provided and an installing direction of the current sensor.

### Solution to Problem

To achieve the above object, a distributed power generation system of the present invention is a distributed power generation system connected to a three-wire electric power system including first to third electric wires, the third electric wire being a neutral wire, and includes: an electric power generator; a connection mechanism configured to connect any two electric wires among the first to third electric wires to an internal electric power load; a first current sensor set so as to detect a current value of the first electric wire; a second current sensor set so as to detect a current value of the second electric wire; and a controller configured to determine the electric wire on which each of the first current sensor and the second current sensor is provided and an installing direction of each of the first current sensor and the second current sensor by determining whether or not an amount of change in the current value detected by each of the first current sensor and the second current sensor before and after the connection mechanism connects said any two electric wires to the internal electric power load is an amount corresponding to power consumption of the internal electric power load.

With this, the electric wire on which the current sensor is provided and the installing direction of the current sensor can be determined by the simple configuration.

The above object, other objects, features and advantages of the present invention will be made clear by the following detailed explanation of preferred embodiments with reference to the attached drawings.

### Advantageous Effects of Invention

According to the distributed power generation system of the present invention, the electric wire on which the current sensor is provided and the installing direction of the current sensor can be determined by the simple configuration.

### BRIEF DESCRIPTION OF DRAWINGS

FIG. 1 is a block diagram schematically showing the schematic configuration of a distributed power generation system according to Embodiment 1 of the present invention.

FIG. 2A is a flow chart schematically showing installed state confirmation operations of a first current sensor and second current sensor in the distributed power generation system according to Embodiment 1.

FIG. 2B is a flow chart schematically showing the installed state confirmation operations of the first current sensor and second current sensor in the distributed power generation system according to Embodiment 1.

FIGS. 3A, 3B, and 3C are flow charts each schematically showing the installed state confirmation operations of the first current sensor and second current sensor in the distributed power generation system according to Embodiment 1.

FIGS. 3A, 3B, and 3C are flow charts each schematically showing the installed state confirmation operations of the first current sensor and second current sensor in the distributed power generation system according to Embodiment 1.

FIGS. 3A, 3B, and 3C are flow charts each schematically showing the installed state confirmation operations of the first current sensor and second current sensor in the distributed power generation system according to Embodiment 1.

FIG. 4A is a flow chart schematically showing the installed state confirmation operation of the first current sensor in the distributed power generation system of Modification Example 1.

FIG. 4B is a flow chart schematically showing the installed state confirmation operation of the first current sensor in the distributed power generation system of Modification Example 1.

FIG. 4C is a flow chart schematically showing the installed state confirmation operation of the first current sensor in the distributed power generation system of Modification Example 1.

FIG. 5A is a flow chart schematically showing the installed state confirmation operation of the second current sensor in the distributed power generation system of Modification Example 1.

FIG. 5B is a flow chart schematically showing the installed state confirmation operation of the second current sensor in the distributed power generation system of Modification Example 1.

FIG. 5C is a flow chart schematically showing the installed state confirmation operation of the second current sensor in the distributed power generation system of Modification Example 1.

FIG. 6 is a block diagram schematically showing the schematic configuration of the distributed power generation system according to Embodiment 2 of the present invention.

FIG. 7 is a flow chart schematically showing the installed state confirmation operation of the first current sensor in the distributed power generation system according to Embodiment 2 of the present invention.

FIG. 8 is a flow chart schematically showing the installed state confirmation operation of the second current sensor in the distributed power generation system of Modification Example of Embodiment 2.

FIG. 9 is a block diagram showing the schematic configuration of the distributed power generation system disclosed in PTL 1.

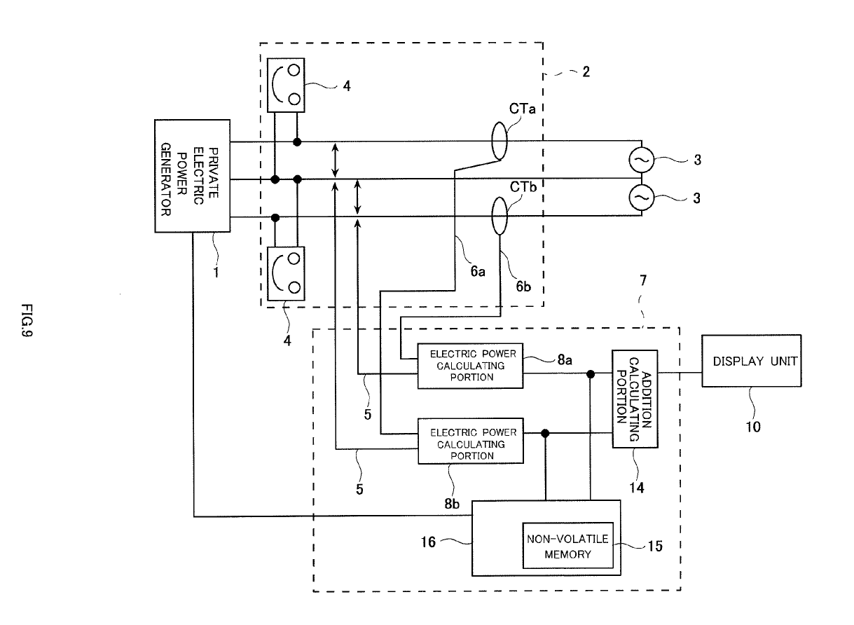

### DESCRIPTION OF EMBODIMENTS

Hereinafter, preferred embodiments of the present invention will be explained in reference to the drawings. In the drawings, the same reference signs are used for the same or corresponding components, and a repetition of the same explanation is avoided. Moreover, in the drawings, only components necessary to explain the present invention are shown, and the other components are omitted. Further, the present invention is not limited to the following embodiments.

### Embodiment 1

A distributed power generation system according to Embodiment 1 of the present invention is a distributed power generation system connected to a three-wire electric power system including first to third electric wires, the third electric wire being a neutral wire, and includes: an electric power generator; a connection mechanism configured to connect any two electric wires among the first to third electric wires to an internal electric power load; a first current sensor set so as to detect a current value of the first electric wire; a second current sensor set so as to detect a current value of the second electric wire; and a controller configured to determine the electric wire on which each of the first current sensor and the second current sensor is provided and an installing direction of each of the first current sensor and the second current sensor by determining whether or not an amount of change in the current value detected by each of the first current sensor and the second current sensor before and after the connection mechanism connects said any two electric wires to the internal electric power load is an amount corresponding to power consumption of the internal electric power load.

Here, the phrase “current value detected by the current sensor” denotes not only the magnitude (amount) of the current flowing through the electric wire but also the direction in which the current flows. Therefore, the phrase “amount of change in the current value” denotes not only the magnitude (amount) of change in the current value but also the direction of change in the current value.

In the distributed power generation system according to Embodiment 1, the connection mechanism may include a first connector configured to connect the first electric wire and the third electric wire to the internal electric power load and a second connector configured to connect the second electric wire and the third electric wire to the internal electric power load.

In the distributed power generation system according to Embodiment 1, the controller may be configured to determine that the first current sensor is provided on the first electric wire in a case where the amount of change in the current value detected by the first current sensor before and after the first connector connects the first electric wire and the third electric wire to the internal electric power load is the amount corresponding to the power consumption of the electric power load and the amount of change in the current value detected by the first current sensor before and after the second connector connects the second electric wire and the third electric wire to the internal electric power load is not the amount corresponding to the power consumption of the electric power load.

In the distributed power generation system according to Embodiment 1, the controller may be configured to determine that the first current sensor is provided on the first electric wire in a right direction in a case where the amount of change in the current value detected by the first current sensor before and after the first connector connects the first electric wire and the third electric wire to the internal electric power load is the amount corresponding to the power consumption of the electric power load and is positive, and the controller may be configured to determine that the first current sensor is provided on the first electric wire in a reverse direction in a case where the amount of change in the current value detected by the first current sensor before and after the first connector connects the first electric wire and the third electric wire to the internal electric power load is the amount corresponding to the power consumption of the electric power load and is negative.

Here, the sentence “first current sensor is provided on the first electric wire in a right direction” denotes that the first current sensor is provided on the first electric wire in a direction in which the first current sensor should be normally provided. Moreover, the sentence “first current sensor is provided on the first electric wire in a reverse direction” denotes that the first current sensor is provided on the first electric wire in a direction opposite to the direction in which the first current sensor should be normally provided.

In the distributed power generation system according to Embodiment 1, the controller may be configured to determine that the first current sensor is provided on the second electric wire in a case where the amount of change in the current value detected by the first current sensor before and after the first connector connects the first electric wire and the third electric wire to the internal electric power load is not the amount corresponding to the power consumption of the electric power load and the amount of change in the current value detected by the first current sensor before and after the second connector connects the second electric wire and the third electric wire to the internal electric power load is the amount corresponding to the power consumption of the electric power load.

In the distributed power generation system according to Embodiment 1, the controller may be configured to determine that the first current sensor is provided on the second electric wire in a right direction in a case where the amount of change in the current value detected by the first current sensor before and after the second connector connects the second electric wire and the third electric wire to the internal electric power load is the amount corresponding to the power consumption of the electric power load and is positive, and the controller may be configured to determine that the first current sensor is provided on the second electric wire in a reverse direction in a case where the amount of change in the current value detected by the first current sensor before and after the second connector connects the second electric wire and the third electric wire to the internal electric power load is the amount corresponding to the power consumption of the electric power load and is negative.

Here, the sentence “first current sensor is provided on the second electric wire in a right direction” denotes that the first current sensor is provided on the second electric wire in a direction in which the first current sensor should be normally provided. Moreover, the sentence “first current sensor is provided on the second electric wire in a reverse direction” denotes that the first current sensor is provided on the second electric wire in a direction opposite to the direction in which the first current sensor should be normally provided.

In the distributed power generation system according to Embodiment 1, the controller may be configured to determine that the first current sensor is provided on the third electric wire in a case where each of both the amount of change in the current value detected by the first current sensor before and after the first connector connects the first electric wire and the third electric wire to the internal electric power load and the amount of change in the current value detected by the first current sensor before and after the second connector connects the second electric wire and the third electric wire to the internal electric power load is the amount corresponding to the power consumption of the electric power load.

In the distributed power generation system according to Embodiment 1, the controller may be configured to determine that the first current sensor is abnormal in a case where each of both the amount of change in the current value detected by the first current sensor before and after the first connector connects the first electric wire and the third electric wire to the internal electric power load and the amount of change in the current value detected by the first current sensor before and after the second connector connects the second electric wire and the third electric wire to the internal electric power load is not the amount corresponding to the power consumption of the electric power load.

Here, the sentence “first current sensor is abnormal” denotes not only a case where the failure of the first current sensor has occurred but also a case where the first current sensor has come off from the electric wire.

In the distributed power generation system according to Embodiment 1, the controller may be configured to determine that the second current sensor is provided on the second electric wire in a case where the amount of change in the current value detected by the second current sensor before and after the first connector connects the first electric wire and the third electric wire to the internal electric power load is not the amount corresponding to the power consumption of the electric power load and the amount of change in the current value detected by the second current sensor before and after the second connector connects the second electric wire and the third electric wire to the internal electric power load is the amount corresponding to the power consumption of the electric power load.

In the distributed power generation system according to Embodiment 1, the controller may be configured to determine that the second current sensor is provided on the second electric wire in a right direction in a case where the amount of change in the current value detected by the second current sensor before and after the second connector connects the second electric wire and the third electric wire to the internal electric power load is the amount corresponding to the power consumption of the electric power load and is positive, and the controller may be configured to determine that the second current sensor is provided on the second electric wire in a reverse direction in a case where the amount of change in the current value detected by the second current sensor before and after the second connector connects the second electric wire and the third electric wire to the internal electric power load is the amount corresponding to the power consumption of the electric power load and is negative.

Here, the sentence “second current sensor is provided on the second electric wire in a right direction” denotes that the second current sensor is provided on the second electric wire in a direction in which the second current sensor should be normally provided. Moreover, the sentence “second current sensor is provided on the second electric wire in a reverse direction” denotes that the second current sensor is provided on the second electric wire in a direction opposite to the direction in which the second current sensor should be normally provided.

In the distributed power generation system according to Embodiment 1, the controller may be configured to determine that the second current sensor is provided on the first electric wire in a case where the amount of change in the current value detected by the second current sensor before and after the first connector connects the first electric wire and the third electric wire to the internal electric power load is the amount corresponding to the power consumption of the electric power load and the amount of change in the current value detected by the second current sensor before and after the second connector connects the second electric wire and the third electric wire to the internal electric power load is not the amount corresponding to the power consumption of the electric power load.

In the distributed power generation system according to Embodiment 1, the controller may be configured to determine that the second current sensor is provided on the first electric wire in a right direction in a case where the amount of change in the current value detected by the second current sensor before and after the first connector connects the first electric wire and the third electric wire to the internal electric power load is the amount corresponding to the power consumption of the electric power load and is positive, and the controller may be configured to determine that the second current sensor is provided on the first electric wire in a reverse direction in a case where the amount of change in the current value detected by the second current sensor before and after the first connector connects the first electric wire and the third electric wire to the internal electric power load is the amount corresponding to the power consumption of the electric power load and is negative.

Here, the sentence “second current sensor is provided on the first electric wire in a right direction” denotes that the second current sensor is provided on the first electric wire in a direction in which the second current sensor should be normally provided. Moreover, the sentence “second current sensor is provided on the first electric wire in a reverse direction” denotes that the second current sensor is provided on the first electric wire in a direction opposite to the direction in which the second current sensor should be normally provided.

In the distributed power generation system according to Embodiment 1, the controller may be configured to determine that the second current sensor is provided on the third electric wire in a case where each of both the amount of change in the current value detected by the second current sensor before and after the first connector connects the first electric wire and the third electric wire to the internal electric power load and the amount of change in the current value detected by the second current sensor before and after the second connector connects the second electric wire and the third electric wire to the internal electric power load is the amount corresponding to the power consumption of the electric power load.

In the distributed power generation system according to Embodiment 1, the controller may be configured to determine that the second current sensor is abnormal in a case where each of both the amount of change in the current value detected by the second current sensor before and after the first connector connects the first electric wire and the third electric wire to the internal electric power load and the amount of change in the current value detected by the second current sensor before and after the second connector connects the second electric wire and the third electric wire to the internal electric power load is not the amount corresponding to the power consumption of the electric power load.

Here, the sentence “second current sensor is abnormal” denotes not only a case where the failure of the second current sensor has occurred but also a case where the second current sensor has come off from the electric wire.

The distributed power generation system according to Embodiment 1 may further include an operating unit configured to operate the controller, wherein the controller may be configured to, by an operation command of the operating unit, start determining the electric wire on which each of the first current sensor and the second current sensor is provided and the installing direction of each of the first current sensor and the second current sensor.

Further, the distributed power generation system according to Embodiment 1 may further include a display unit configured to display results of determinations of the first current sensor and the second current sensor by the controller.

Configuration of Distributed Power Generation System

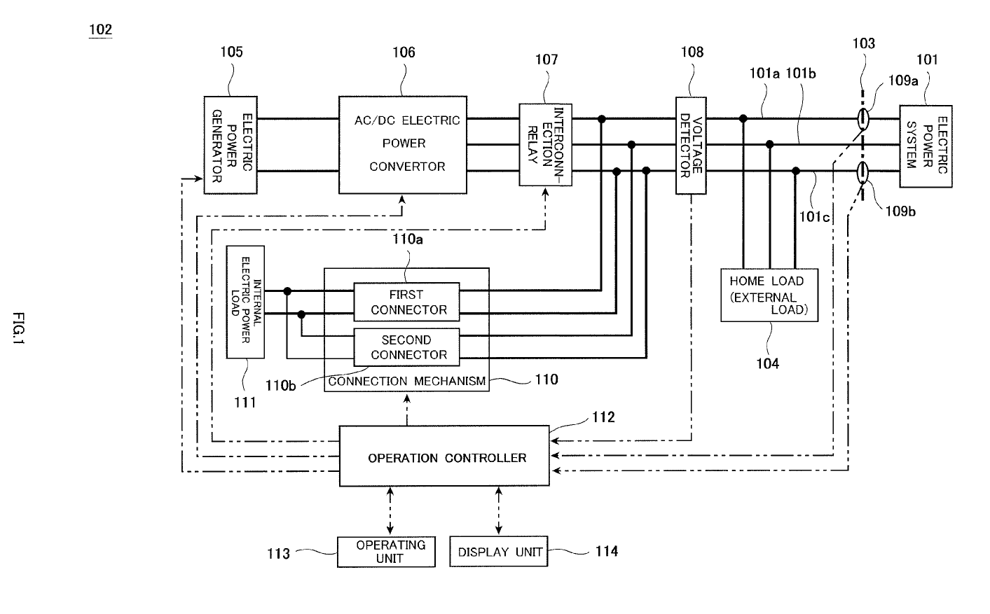

First, the configuration of the distributed power generation system according to Embodiment 1 of the present invention will be explained in reference to FIG. 1.

FIG. 1 is a block diagram schematically showing the schematic configuration of the distributed power generation system according to Embodiment 1 of the present invention.

In FIG. 1, an electric power system 101, a distributed power generation system 102, and a home load 104 are shown. Here, the electric power system 101 is a single-phase three-wire AC power supply constituted by a first electric wire 101a, a second electric wire 101b, and a third electric wire 101c. The electric power system 101 and the distributed power generation system 102 are interconnected at an interconnection point 103.

The home load 104 is a TV, an air conditioner, or the like used in ordinary households and is a device which consumes AC power supplied from the electric power system 101 or the distributed power generation system 102. In the following explanation, the first electric wire 101a is referred to as a U phase 101a, the second electric wire 101b is referred to as a W phase 101b, and the third electric wire 101c is referred to as an O phase 101c that is a neutral wire.

The distributed power generation system 102 is constituted by at least an electric power generator 105, an AC/DC electric power converter 106, an interconnection relay 107, a voltage detector 108, a first current sensor 109a, a second current sensor 109b, a connection mechanism 110, an internal electric power load 111, an operation controller (controller) 112, an operating unit 113, and a display unit 114.

Here, the electric power generator 105 is constituted by a fuel cell and the like and generates DC power. The AC/DC electric power converter 106 is configured to include an isolation transformer. The AC/DC electric power converter 106 transforms the DC voltage generated by the electric power generator 105 and then converts the DC power into AC power consumable by the home load 104. The interconnection relay 107 is configured to be opened or closed to interconnect or disconnect the distributed power generation system 102 and the electric power system 101.

The voltage detector 108 may be any device as long as it is configured to detect voltage between the U phase 101a and the O phase 101c and voltage between the W phase 101b and the O phase 101c in the electric power system 101. Each of the first current sensor 109a and the second current sensor 109b is attached to the electric wire of the electric power system 101 and is configured to detect the magnitude of a current flowing through a position where the first current sensor 109a or the second current sensor 109b is attached and a positive or negative direction of the current. For example, a current transformer may be used as each of the first current sensor 109a and the second current sensor 109b. In Embodiment 1, the first current sensor 109a is set so as to be attached to the interconnection point 103 of the U phase 101a, and the second current sensor 109b is set so as to be attached to the interconnection point 103 of the W phase 101b.

The internal electric power load 111 is constituted by a device, such as a heater, whose electric power consumption is comparatively high. The internal electric power load 111 is configured to be connected through the connection mechanism 110 to the U and O phases 101a and 101c or the W and O phases 101b and 101c in the electric power system 101. The internal electric power load 111 is connected to the electric power system 101 by the connection mechanism 110 to consume the electric power.

In Embodiment 1, the connection mechanism 110 includes a first connector 110a and a second connector 110b. When the first connector 110a is in an on state, the first connector 110a connects the internal electric power load 111 to the U phase 101a and the O phase 101c in the electric power system 101. When the second connector 110b is in an on state, the second connector 110b connects the internal electric power load 111 to the W phase 101b and the O phase 101c in the electric power system 101. The connection mechanism 110 turns on any one of the first connector 110a and the second connector 110b based on a command from the operation controller 112 to realize the supply of the electric power to the internal electric power load 111.

The operation controller 112 may be any device as long as it is a device configured to control respective devices constituting the distributed power generation system 102. For example, the operation controller 112 includes a calculation processing portion, such as a microprocessor or a CPU, and a storage portion, such as a non-volatile memory, configured to store programs for executing respective control operations. In the operation controller 112, the calculation processing portion reads out and executes a predetermined control program stored in the storage portion. Thus, the operation controller 112 processes the information and performs various control operations, such as the above control operations, regarding the distributed power generation system 102.

Specifically, based on an electric power value calculated from the product of the voltage value detected by the voltage detector 108 and the current value detected by the first current sensor 109a and/or the current value detected by the second current sensor 109b, the operation controller 112 controls the output of the electric power generator 105, the output of the AC/DC electric power converter 106, on or off of the interconnection relay 107, and on or off of the connection mechanism 110. In addition, by using the connection mechanism 110, the operation controller 112 switches the connection of the internal electric power load 111 to the electric power system 101, between through the U phase 101a and the O phase 101c and through the W phase 101b and the O phase 101c. Thus, the operation controller 112 determines abnormalities, such as failures, wire breaking, and come-off states, of the first current sensor 109a and the second current sensor 109b, and attached directions and attached positions of the first current sensor 109a and the second current sensor 109b.

The operation controller 112 may be constituted by a single controller or by a group of a plurality of controllers which cooperate to execute control operations of the distributed power generation system 102. The operation controller 112 may be constituted by a microcontroller or by a MPU, a PLC (programmable logic controller), a logic circuit, or the like.

The operating unit 113 is configured such that an installer or maintenance worker can perform predetermined operations regarding the distributed power generation system 102. Examples of the operating unit 113 are a tact switch and a membrane switch. The display unit 114 is configured to display, for example, error indications and operation information of the distributed power generation system 102. Examples of the display unit 114 are a LCD and a seven-segment LED.

Operations of Distributed Power Generation System

Next, operations of the distributed power generation system 102 according to Embodiment 1 will be explained.

First, a relation among the amount of change in the current value detected by the first current sensor 109a or the second current sensor 109b before and after the connection mechanism 110 connects the internal electric power load 111 and the electric power system 101, the electric wire on which the first current sensor 109a or the second current sensor 109b is provided, and the installing direction of the first current sensor 109a or the second current sensor 109b will be explained.

(1) A Case Where First Current Sensor 109a is Provided on U Phase 101a in Right Direction

As shown in FIG. 1, in a case where the first current sensor 109a is provided on the U phase 101a in the right direction, the amount of change in the current value detected by the first current sensor 109a before and after the internal electric power load 111 is connected to the first electric wire (U phase) 101a and the third electric wire (0 phase) 101c in the electric power system 101 becomes the amount corresponding to the power consumption of the internal electric power load 111. Specifically, the amount of change in the current value detected by the first current sensor 109a significantly changes to the positive side.

Meanwhile, the amount of change in the current value detected by the first current sensor 109a before and after the internal electric power load 111 is connected to the second electric wire (W phase) 101b and the third electric wire (O phase) 101c in the electric power system 101 is within a predetermined range. To be specific, the amount of change in the current value detected by the first current sensor 109a changes little.

Therefore, in a case where the amount of change in the current value detected by the first current sensor 109a before and after the internal electric power load 111 is connected to the first electric wire (U phase) 101a and the third electric wire (O phase) 101c in the electric power system 101 is a value on the positive side of the predetermined range and the amount of change in the current value detected by the first current sensor 109a before and after the internal electric power load 111 is connected to the second electric wire (W phase) 101b and the third electric wire (O phase) 101c in the electric power system 101 is within the predetermined range, the operation controller 112 can determine that the first current sensor 109a is being provided on the U phase 101a in the right direction.

(2) A Case Where First Current Sensor 109a is Provided on U phase 101a in Reverse Direction

In a case where the first current sensor 109a is provided on the U phase 101a in a reverse direction in FIG. 1, the amount of change in the current value detected by the first current sensor 109a before and after the internal electric power load 111 is connected to the first electric wire (U phase) 101a and the third electric wire (O phase) 101c in the electric power system 101 becomes the amount corresponding to the power consumption of the internal electric power load 111 and changes to the negative side. To be specific, the amount of change in the current value detected by the first current sensor 109a significantly changes to the negative side.

Meanwhile, the amount of change in the current value detected by the first current sensor 109a before and after the internal electric power load 111 is connected to the second electric wire (W phase) 101b and the third electric wire (O phase) 101c in the electric power system 101 is within the predetermined range. Specifically, the amount of change in the current value detected by the first current sensor 109a changes little.

Therefore, in a case where the amount of change in the current value detected by the first current sensor 109a before and after the internal electric power load 111 is connected to the first electric wire (U phase) 101a and the third electric wire (O phase) 101c in the electric power system 101 is a value on the negative side of the predetermined range and the amount of change in the current value detected by the first current sensor 109a before and after the internal electric power load 111 is connected to the second electric wire (W phase) 101b and the third electric wire (O phase) 101c in the electric power system 101 is within the predetermined range, the operation controller 112 can determine that the first current sensor 109a is being provided on the U phase 101a in the reverse direction.

(3) A Case Where First Current Sensor 109a is Provided on W Phase 101b

In a case where the first current sensor 109a is provided on the W phase 101b in FIG. 1, the amount of change in the current value detected by the first current sensor 109a before and after the internal electric power load 111 is connected to the first electric wire (U phase) 101a and the third electric wire (O phase) 101c in the electric power system 101 is within the predetermined range.

Meanwhile, the amount of change in the current value detected by the first current sensor 109a before and after the internal electric power load 111 is connected to the second electric wire (W phase) 101b and the third electric wire (O phase) 101c in the electric power system 101 becomes a value outside the predetermined range.

Therefore, in a case where the amount of change in the current value detected by the first current sensor 109a before and after the internal electric power load 111 is connected to the first electric wire (U phase) 101a and the third electric wire (O phase) 101c in the electric power system 101 is within the predetermined range and the amount of change in the current value detected by the first current sensor 109a before and after the internal electric power load 111 is connected to the second electric wire (W phase) 101b and the third electric wire (O phase) 101c in the electric power system 101 is outside the predetermined range, the operation controller 112 can determine that the first current sensor 109a is being provided on the W phase 101b.

In this case, in a case where the amount of change in the current value detected by the first current sensor 109a is a value on the positive side of the predetermined range, the operation controller 112 can determine that the first current sensor 109a is being provided on the W phase 101b in the right direction. In contrast, in a case where the amount of change in the current value detected by the first current sensor 109a is a value on the negative side of the predetermined range, the operation controller 112 can determine that the first current sensor 109a is being provided on the W phase 101b in the reverse direction.

(4) A Case Where First Current Sensor 109a is Provided on O phase 101c

In a case where the first current sensor 109a is provided on the O phase 101c in FIG. 1, the amount of change in the current value detected by the first current sensor 109a before and after the internal electric power load 111 is connected to the first electric wire (U phase) 101a and the third electric wire (O phase) 101c in the electric power system 101 becomes a value outside the predetermined range.

Moreover, the amount of change in the current value detected by the first current sensor 109a before and after the internal electric power load 111 is connected to the second electric wire (W phase) 101b and the third electric wire (O phase) 101c in the electric power system 101 becomes a value outside the predetermined range.

Therefore, in a case where the amount of change in the current value detected by the first current sensor 109a before and after the internal electric power load 111 is connected to the first electric wire (U phase) 101a and the third electric wire (O phase) 101c in the electric power system 101 is outside the predetermined range and the amount of change in the current value detected by the first current sensor 109a before and after the internal electric power load 111 is connected to the second electric wire (W phase) 101b and the third electric wire (O phase) 101c in the electric power system 101 is outside the predetermined range, the operation controller 112 can determine that the first current sensor 109a is being provided on the O phase 101c.

(5) A Case Where Second Current Sensor 109b is Provided on W Phase 101b in Right Direction

As shown in FIG. 1, in a case where the second current sensor 109b is provided on the W phase 101b in the right direction, the amount of change in the current value detected by the second current sensor 109b before and after the internal electric power load 111 is connected to the second electric wire (W phase) 101b and the third electric wire (O phase) 101c in the electric power system 101 becomes the amount corresponding to the power consumption of the internal electric power load 111. Specifically, the amount of change in the current value detected by the second current sensor 109b significantly changes to the positive side.

Meanwhile, the amount of change in the current value detected by the second current sensor 109b before and after the internal electric power load 111 is connected to the first electric wire (U phase) 101a and the third electric wire (O phase) 101c in the electric power system 101 is within the predetermined range. To be specific, the amount of change in the current value detected by the second current sensor 109b changes little.

Therefore, in a case where the amount of change in the current value detected by the second current sensor 109b before and after the internal electric power load 111 is connected to the second electric wire (W phase) 101b and the third electric wire (O phase) 101c in the electric power system 101 is a value on the positive side of the predetermined range and the amount of change in the current value detected by the second current sensor 109b before and after the internal electric power load 111 is connected to the first electric wire (U phase) 101a and the third electric wire (O phase) 101c in the electric power system 101 is within the predetermined range, the operation controller 112 can determine that the second current sensor 109b is being provided on the W phase 101b in the right direction.

(6) A Case Where Second Current Sensor 109b is Provided on W Phase 101b in Reverse Direction

In a case where the second current sensor 109b is provided on the W phase 101b in the reverse direction in FIG. 1, the amount of change in the current value detected by the second current sensor 109b before and after the internal electric power load 111 is connected to the second electric wire (W phase) 101b and the third electric wire (0 phase) 101c in the electric power system 101 becomes the amount corresponding to the power consumption of the internal electric power load 111 and changes to the negative side. Specifically, the amount of change in the current value detected by the second current sensor 109b significantly changes to the negative side.

Meanwhile, the amount of change in the current value detected by the second current sensor 109b before and after the internal electric power load 111 is connected to the first electric wire (U phase) 101a and the third electric wire (O phase) 101c in the electric power system 101 is within the predetermined range. To be specific, the amount of change in the current value detected by the second current sensor 109b changes little.

Therefore, in a case where the amount of change in the current value detected by the second current sensor 109b before and after the internal electric power load 111 is connected to the second electric wire (W phase) 101b and the third electric wire (0 phase) 101c in the electric power system 101 is a value on the negative side of the predetermined range and the amount of change in the current value detected by the second current sensor 109b before and after the internal electric power load 111 is connected to the first electric wire (U phase) 101a and the third electric wire (O phase) 101c in the electric power system 101 is within the predetermined range, the operation controller 112 can determine that the second current sensor 109b is being provided on the W phase 101b in the reverse direction.

(7) A Case Where Second Current Sensor 109b is Provided on U phase 101a

In a case where the second current sensor 109b is provided on the U phase 101a in FIG. 1, the amount of change in the current value detected by the second current sensor 109b before and after the internal electric power load 111 is connected to the second electric wire (W phase) 101b and the third electric wire (O phase) 101c in the electric power system 101 is within the predetermined range.

Meanwhile, the amount of change in the current value detected by the second current sensor 109b before and after the internal electric power load 111 is connected to the first electric wire (U phase) 101a and the third electric wire (O phase) 101c in the electric power system 101 becomes a value outside the predetermined range.

Therefore, in a case where the amount of change in the current value detected by the second current sensor 109b before and after the internal electric power load 111 is connected to the second electric wire (W phase) 101b and the third electric wire (0 phase) 101c in the electric power system 101 is within the predetermined range and the amount of change in the current value detected by the second current sensor 109b before and after the internal electric power load 111 is connected to the first electric wire (U phase) 101a and the third electric wire (O phase) 101c in the electric power system 101 is outside the predetermined range, the operation controller 112 can determine that the second current sensor 109b is being provided on the U phase 101a.

In this case, in a case where the amount of change in the current value detected by the second current sensor 109b is a value on the positive side of the predetermined range, the operation controller 112 can determine that the second current sensor 109b is being provided on the U phase 101a in the right direction. Moreover, in a case where the amount of change in the current value detected by the second current sensor 109b is a value on the negative side of the predetermined range, the operation controller 112 can determine that the second current sensor 109b is being provided on the U phase 101a in the reverse direction.

(8) A Case Where Second Current Sensor 109b is Provided on O phase 101c

In a case where the second current sensor 109b is provided on the O phase 101c in FIG. 1, the amount of change in the current value detected by the second current sensor 109b before and after the internal electric power load 111 is connected to the first electric wire (U phase) 101a and the third electric wire (O phase) 101c in the electric power system 101 becomes a value outside the predetermined range.

Moreover, the amount of change in the current value detected by the second current sensor 109b before and after the internal electric power load 111 is connected to the second electric wire (W phase) 101b and the third electric wire (O phase) 101c in the electric power system 101 becomes a value outside the predetermined range.

Therefore, in a case where the amount of change in the current value detected by the second current sensor 109b before and after the internal electric power load 111 is connected to the first electric wire (U phase) 101a and the third electric wire (O phase) 101c in the electric power system 101 is outside the predetermined range and the amount of change in the current value detected by the second current sensor 109b before and after the internal electric power load 111 is connected to the second electric wire (W phase) 101b and the third electric wire (O phase) 101c in the electric power system 101 is outside the predetermined range, the operation controller 112 can determine that the second current sensor 109b is being provided on the O phase 101c.

(9) Other Case

Here, in a case where each of the amount of change in the current value detected by the first current sensor 109a or the second current sensor 109b before and after the internal electric power load 111 is connected to the first electric wire (U phase) 101a and the third electric wire (O phase) 101c in the electric power system 101 and the amount of change in the current value detected by the first current sensor 109a or the second current sensor 109b before and after the internal electric power load 111 is connected to the second electric wire (W phase) 101b and the third electric wire (O phase) 101c in the electric power system 101 is within the predetermined range, the operation controller 112 can determine that the first current sensor 109a or the second current sensor 109b has come off from the electric wire or the failure of the first current sensor 109a or the second current sensor 109b is occurring.

Therefore, in a case where each of the amount of change in the current value detected by the first current sensor 109a or the second current sensor 109b before and after the internal electric power load 111 is connected to the first electric wire (U phase) 101a and the third electric wire (O phase) 101c in the electric power system 101 and the amount of change in the current value detected by the first current sensor 109a or the second current sensor 109b before and after the internal electric power load 111 is connected to the second electric wire (W phase) 101b and the third electric wire (O phase) 101c in the electric power system 101 is within the predetermined range, the operation controller 112 can determine that the first current sensor 109a or the second current sensor 109b is abnormal.

Installed State Confirmation Operation of Current Sensor

Next, installed state confirmation operations of the first current sensor 109a and second current sensor 109b of the distributed power generation system 102 according to Embodiment 1 will be explained.

First, when the installer or maintenance worker installs or maintenances the distributed power generation system 102, he or she attaches the first current sensor 109a to the interconnection point 103 of the U phase 101a and attaches the second current sensor 109b to the interconnection point 103 of the W phase 101b. Then, the installer or maintenance worker connects an output signal wire to the operation controller 112. After that, in order to confirm whether or not the attached directions, the attached positions, the wiring of the first current sensor 109a and the second current sensor 109b are properly set by the installation or the maintenance, the installer or maintenance worker performs predetermined operations by using the operating unit 113 to perform attached state confirmation tests.

Operation of Confirming Whether Sensor is not Attached to O Phase

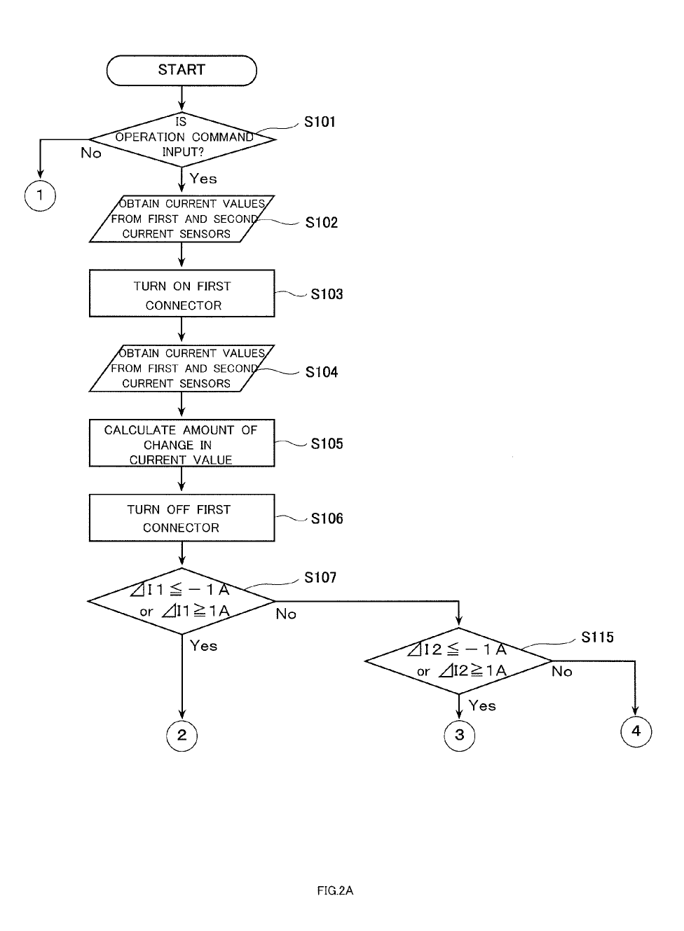

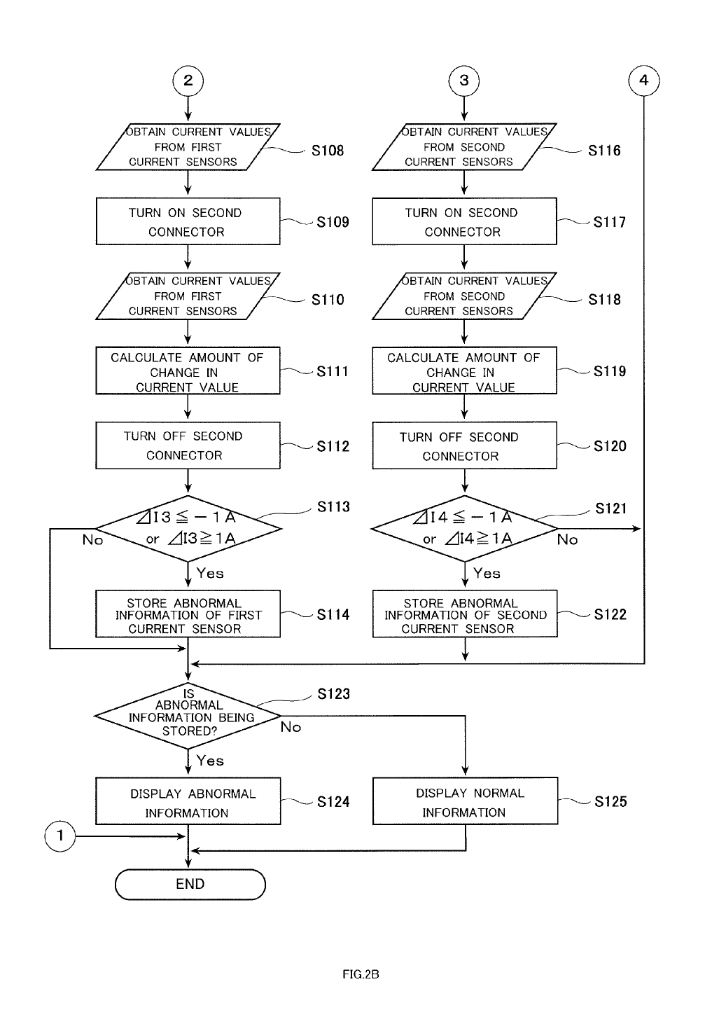

First, a case where the operation controller 112 determines whether the first current sensor 109a and the second current sensor 109b are not mistakenly attached to the third electric wire that is the O phase 101c will be explained in reference to FIGS. 1, 2A, and 2B. Each of FIGS. 2A and 2B is a flow chart schematically showing the installed state confirmation operations of the first current sensor and second current sensor in the distributed power generation system according to Embodiment 1. More specifically, each of FIGS. 2A and 2B is a flow chart showing the operation of confirming whether or not the first current sensor and the second current sensor are provided on the O phase.

As shown in FIGS. 2A and 2B, when the operation controller 112 receives an operation signal from the operating unit 113, the operation controller 112 starts the confirmation test (Yes in Step S101). Specifically, the operation controller 112 obtains current values detected by the first current sensor 109a and the second current sensor 109b (Step S102).

Next, the operation controller 112 outputs to the connection mechanism 110 a command for turning on the first connector 110a (Step S103). With this, since the first connector 110a connects the internal electric power load 111 to the U phase 101a and the O phase 101c, a current flows through the interconnection point 103 of the U phase 101a.

At this time, the operation controller 112 again obtains the current values detected by the first current sensor 109a and the second current sensor 109b (Step S104) and calculates the amount of change in the current value from the current value obtained in Step S102 (in the present embodiment, the amount of change in the current value in the first current sensor 109a from Step S102 is represented by ΔI1, and the amount of change in the current value in the second current sensor 109b from Step S102 is represented by ΔI2) (Step S105).

Next, the operation controller 112 outputs to the connection mechanism 110 a command for turning off the first connector 110a (Step S106). With this, since the first connector 110a cancels the connection between the internal electric power load 111 and each of the U phase 101a and the O phase 101c, the current does not flow through the interconnection point 103 of the U phase 101a.

Here, in a case where the current value detected by the first current sensor 109a has changed so as to correspond to the amount of electric power consumed by the internal electric power load 111 when the first connector 110a has been turned on and off, to be specific, in a case where ΔI1 is outside a predetermined range (in the present embodiment, a range from −1 A to 1 A) (Yes in Step S107), the operation controller 112 proceeds to Step S108. In contrast, in a case where ΔI1 is within the predetermined range (No in Step S107), the operation controller 112 proceeds to Step S115. The predetermined range may be set arbitrarily within a range adequately smaller than the amount of change corresponding to the amount of electric power consumed by the internal electric power load 111. Specifically, the predetermined range may be set to, for example, values corresponding to 10 to 30% of a value of the current flowing through the electric wire, the value being calculated from the value of the electric power consumed by the internal electric power load 111.

In Step S108, the operation controller 112 obtains the current value detected by the first current sensor 109a. Next, the operation controller 112 outputs to the connection mechanism 110 a command for turning on the second connector 110b (Step S109). With this, since the second connector 110b connects the internal electric power load 111 to the W phase 101b and the O phase 101c, the current flows through the interconnection point 103 of the W phase 101b.

At this time, the operation controller 112 again obtains the current value detected by the first current sensor 109a (Step S110) and calculates the amount of change in the current value from the current value obtained in Step S108 (in the present embodiment, the amount of change in the current value in the first current sensor 109a from Step S108 is represented by ΔI3) (Step S111).

Next, the operation controller 112 outputs to the connection mechanism 110 a command for turning off the second connector 110b (Step S112). With this, since the second connector 110b cancels the connection between the internal electric power load 111 and each of the W phase 101b and the O phase 101c, the current does not flow through the interconnection point 103 of the W phase 101b.

Here, in a case where the current value detected by the first current sensor 109a has changed so as to correspond to the amount of electric power consumed by the internal electric power load 111 when the second connector 110b has been turned on and off, to be specific, in a case where ΔI3 is outside the predetermined range (in the present embodiment, a range from −1 A to 1 A) (Yes in Step S113), the operation controller 112 can determine that the first current sensor 109a is being mistakenly attached to the interconnection point 103 of the O phase 101c. To be specific, in a case where the amount of change in the current value detected by the first current sensor 109a before and after the first connector 110a is turned on or off is outside the predetermined range (Yes in Step S107) and the amount of change in the current value detected by the first current sensor 109a before and after the second connector 110b is turned on or off is outside the predetermined range (Yes in Step S113), the operation controller 112 can determine that the first current sensor 109a is being attached to the interconnection point 103 of the O phase 101c.

Therefore, in a case where ΔI3 is outside the predetermined range (Yes in Step S113), the operation controller 112 stores this information as abnormal information in the embedded non-volatile memory (storage portion) (Step S114), and the operation controller 112 proceeds to Step S123. In contrast, in a case where ΔI3 is within the predetermined range (No in Step S113), the operation controller 112 proceeds to Step S123.

In Step S123, the operation controller 112 determines whether or not the abnormal information is being stored in the embedded non-volatile memory. In a case where the abnormal information is being stored in the embedded non-volatile memory (Yes in Step S123), the operation controller 112 causes the display unit 114 to display the abnormal information (Step S124). In a case where the abnormal information is not stored in the embedded non-volatile memory (No in Step S123), the operation controller 112 causes the display unit 114 to display normal information (Step S125).

In contrast, as described above, in a case where ΔI1 is within the predetermined range (No in Step S107), the operation controller 112 proceeds to Step S115. In Step S115, the operation controller 112 determines whether or not the current value detected by the second current sensor 109b has changed so as to correspond to the amount of electric power consumed by the internal electric power load 111 when the first connector 110a has been turned on and off.

In a case where ΔI2 is outside the predetermined range (in the present embodiment, a range from −1 A to 1 A) (Yes in Step S115), the operation controller 112 proceeds to Step S116. In contrast, in a case where ΔI2 is within the predetermined range (No in Step S115), the operation controller 112 proceeds to Step S123.

In Step S116, the operation controller 112 obtains the current value detected by the second current sensor 109b. Next, the operation controller 112 outputs to the connection mechanism 110 the command for turning on the second connector 110b (Step S117). With this, since the second connector 110b connects the internal electric power load 111 to the W phase 101b and the O phase 101c, the current flows through the interconnection point 103 of the W phase 101b.

At this time, the operation controller 112 again obtains the current value detected by the second current sensor 109b (Step S118) and calculates the amount of change in the current value from the current value obtained in Step S116 (in the present embodiment, the amount of change in the current value in the second current sensor 109b from Step S116 is represented by ΔI4) (Step S119).

Next, the operation controller 112 outputs to the connection mechanism 110 the command for turning off the second connector 110b (Step S120). With this, since the second connector 110b cancels the connection between the internal electric power load 111 and each of the W phase 101b and the O phase 101c, the current does not flow through the interconnection point 103 of the W phase 101b.

Here, in a case where the current value detected by the second current sensor 109b has changed so as to correspond to the amount of electric power consumed by the internal electric power load 111 when the second connector 110b has been turned on and off, to be specific, in a case where ΔI4 is outside the predetermined range (in the present embodiment, a range from −1 A to 1 A) (Yes in Step S121), the operation controller 112 can determine that the second current sensor 109b is being mistakenly attached to the interconnection point 103 of the O phase 101c. To be specific, in a case where the amount of change in the current value detected by the second current sensor 109b before and after the first connector 110a is turned on or off is outside the predetermined range (Yes in Step S115) and the amount of change in the current value detected by the second current sensor 109b before and after the second connector 110b is turned on or off is outside the predetermined range (Yes in Step S121), the operation controller 112 can determine that the second current sensor 109b is being attached to the interconnection point 103 of the O phase 101c.

Therefore, in a case where ΔI4 is outside the predetermined range (Yes in Step S121), the operation controller 112 stores this information as abnormal information in the embedded non-volatile memory (storage portion) (Step S122) and proceeds to Step S123. In contrast, in a case where ΔI4 is within the predetermined range (No in Step S121), the operation controller 112 proceeds to Step S123.

In Step S123, the operation controller 112 determines whether or not the abnormal information is being stored in the embedded non-volatile memory. In a case where the abnormal information is being stored in the embedded non-volatile memory (Yes in Step S123), the operation controller 112 causes the display unit 114 to display the abnormal information (Step S124). In contrast, in a case where the abnormal information is not stored in the embedded non-volatile memory (No in Step S123), the operation controller 112 causes the display unit 114 to display the normal information (Step S125). Then, the operation controller 112 terminates this program.

Thus, the operation controller 112 can determine whether or not each of the first current sensor 109a and the second current sensor 109b is being mistakenly provided on the O phase.

Operation of Confirming Attached Direction, etc. of Current Sensor

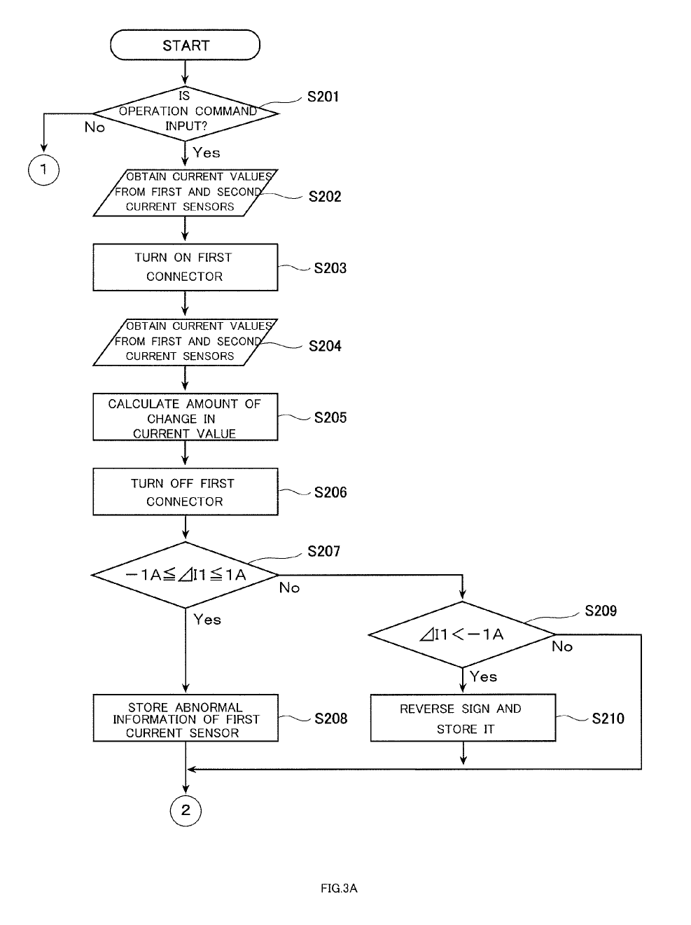

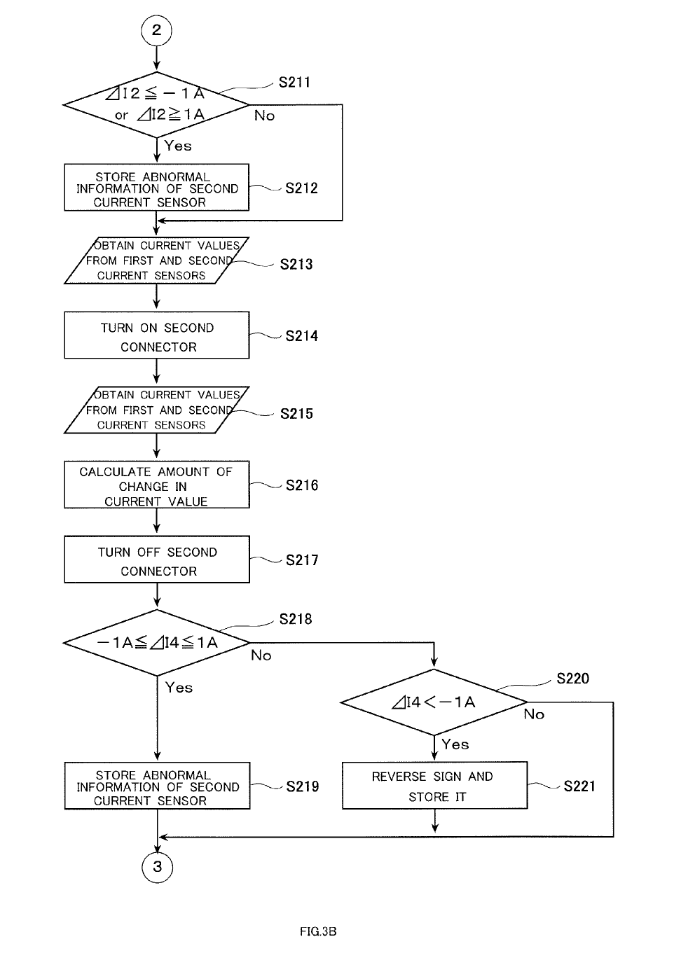

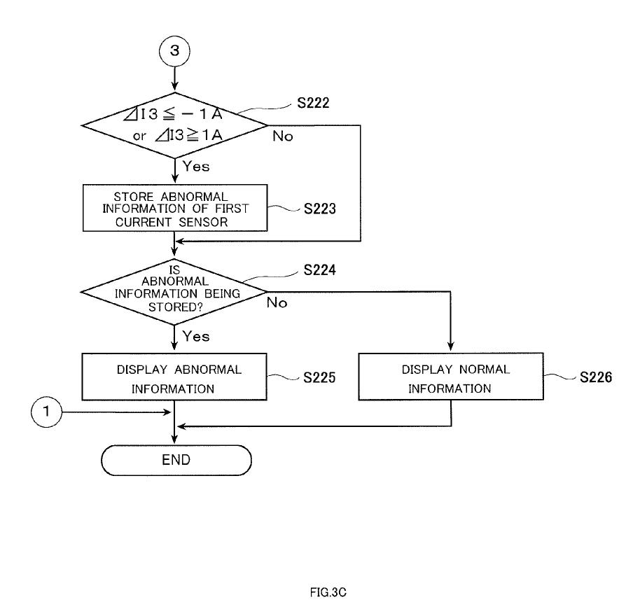

Next, a case where the operation controller 112 determines automatic corrections of the attached directions of the first current sensor 109a and the second current sensor 109b, a state where each of the first current sensor 109a and the second current sensor 109b is attached to a reverse phase, and states, such as failures, wire breaking, and come-off, of the first current sensor 109a and the second current sensor 109b will be explained in reference to FIGS. 1 and 3A to 3C.

FIGS. 3A, 3B, and 3C are flow charts each schematically showing the installed state confirmation operations of the first current sensor and second current sensor in the distributed power generation system according to Embodiment 1. More specifically, FIGS. 3A, 3B, and 3C are flow charts each showing the operations of confirming the attached directions and the like of the first current sensor and the second current sensor.

As shown in FIGS. 3A to 3C, when the operation controller 112 receives the operation signal from the operating unit 113, the operation controller 112 starts the confirmation test (Yes in Step S201). First, the operation controller 112 confirms the failures (in the present embodiment, including the wire breaking and come-off of a signal wire of the first current sensor 109a) of the first current sensor 109a, the attached direction of the first current sensor 109a, that the first current sensor 109a is being properly attached to the interconnection point 103 of the U phase 101a, and that the second current sensor 109b is not being mistakenly attached.

Specifically, the operation controller 112 obtains the current values detected by the first current sensor 109a and the second current sensor 109b (Step S202). Next, the operation controller 112 outputs to the connection mechanism 110 the command for turning on the first connector 110a (Step S203). With this, since the first connector 110a connects the internal electric power load 111 to the U phase 101a and the O phase 101c, the current flows through the interconnection point 103 of the U phase 101a.

At this time, the operation controller 112 again obtains the current values detected by the first current sensor 109a and the second current sensor 109b (Step S204) and calculates the amount of change in the current value from the current value obtained in Step S202 (in the present embodiment, the amount of change in the current value in the first current sensor 109a from Step S202 is represented by AIL and the amount of change in the current value in the second current sensor 109b from Step S202 is represented by ΔI2) (Step S205).

Next, the operation controller 112 outputs to the connection mechanism 110 the command for turning off the first connector 110a (Step S206). With this, since the first connector 110a cancels the connection between the internal electric power load 111 and each of the U phase 101a and the O phase 101c, the current does not flow through the interconnection point 103 of the U phase 101a.

Here, as described above, if the first current sensor 109a is attached to the right position, that is, the interconnection point 103 of the U phase 101a without failures, the current value detected by the first current sensor 109a changes so as to correspond to the amount of electric power consumed by the internal electric power load 111. To be specific, ΔI1 is outside the predetermined range (in Embodiment 1, a range from −1 A to 1 A). In contrast, if the failure, wire breaking, or come-off of the first current sensor 109a has occurred or the first current sensor 109a is being attached to a wrong position, the current value does not change. To be specific, ΔI1 is within the predetermined range.

Therefore, in a case where ΔI1 is within the predetermined range (Yes in Step S207) when the first connector 110a has been turned on and off, the operation controller 112 can determine that the failure, wire breaking, or come-off of the first current sensor 109a has occurred or the first current sensor 109a is being attached on not the interconnection point 103 of the U phase 101a but the electric wire of the reverse phase (for example, the interconnection point 103 of the W phase 101b). Therefore, the operation controller 112 stores in the embedded non-volatile memory (storage portion) the abnormal information indicating that the first current sensor 109a is abnormal (Step S208) and proceeds to Step S211.

In contrast, in a case where ΔI1 is outside the predetermined range (No in Step S207) and the amount of change in the current value of the first current sensor 109a is smaller than a predetermined value (in the present embodiment, smaller than −1 A) (Yes in Step S209), the operation controller 112 can determine that the attached position of the first current sensor 109a is proper (the first current sensor 109a is being attached to the interconnection point 103 of the U phase 101a) but the attached direction thereof is opposite. Therefore, the operation controller 112 reverses the positive and negative of the attached direction of the first current sensor 109a and stores this information in embedded non-volatile memory. After this, the operation controller 112 corrects the sign of the current value detected by the first current sensor 109a by reversing the sign (Step S210). Then, the operation controller 112 proceeds to Step S211.

In Step S211, the operation controller 112 determines whether or not the amount of change (ΔI2) in the current value detected by the second current sensor 109b is outside the predetermined range (in Embodiment 1, a range from −1 A to 1 A).

Here, as described above, if the second current sensor 109b is being mistakenly attached to the interconnection point 103 of the U phase 101a, the current value of the second current sensor 109b changes so as to correspond to the amount of electric power consumed by the internal electric power load 111 when the first connector 110a has been turned on and off.

Therefore, in a case where the amount of change (ΔI2) in the current value of the second current sensor 109b is outside the predetermined range (Yes in Step S211), the operation controller 112 can determine that the second current sensor 109b is being mistakenly attached to the interconnection point 103 of the U phase 101a. On this account, the operation controller 112 stores in the embedded memory the abnormal information indicating that the second current sensor 109b is abnormal (Step S212) and proceeds to Step S213.

In contrast, in a case where ΔI2 is within the predetermined range (No in Step 211), the operation controller 112 proceeds to Step S213.

Next, in Step S213 and the subsequent steps, the operation controller 112 confirms the attached direction of the second current sensor 109b, that the second current sensor 109b is being properly attached to the interconnection point 103 of the W phase 101b, and that the first current sensor 109a is not being mistakenly attached.

In Step S213, the operation controller 112 obtains the current values detected by the first current sensor 109a and the second current sensor 109b. Next, the operation controller 112 outputs to the connection mechanism 110 the command for turning on the second connector 110b (Step S214). With this, since the second connector 110b connects the internal electric power load 111 to the W phase 101b and the O phase 101c, the current flows through the interconnection point 103 of the W phase 101b.

At this time, the operation controller 112 again obtains the current values detected by the first current sensor 109a and the second current sensor 109b (Step S215) and calculates the amount of change in the current value from the current value obtained in Step S213 (in the present embodiment, the amount of change in the current value in the first current sensor 109a from Step S213 is represented by ΔI3, and the amount of change in the current value in the second current sensor 109b from Step S213 is represented by ΔI4) (Step S216).

Next, the operation controller 112 outputs to the connection mechanism 110 the command for turning off the second connector 110b (Step S217). With this, since the second connector 110b cancels the connection between the internal electric power load 111 and each of the W phase 101b and the O phase 101c, the current does not flow through the interconnection point 103 of the W phase 101b.

Here, as described above, if the second current sensor 109b is attached to the right position, that is, the interconnection point 103 of the W phase 101b without failures, the current value detected by the second current sensor 109b changes so as to correspond to the amount of electric power consumed by the internal electric power load 111. To be specific, ΔI4 is outside the predetermined range (in Embodiment 1, a range from −1 A to 1 A). In contrast, if failure, wire breaking, or come-off of the second current sensor 109b has occurred or the second current sensor 109b is being attached to a wrong position, the current value does not change. To be specific, ΔI4 is within the predetermined range.

Therefore, in a case where ΔI4 is within the predetermined range (Yes in Step S218) when the second connector 110b has been turned on and off, the operation controller 112 can determine that the failure, wire breaking, or come-off of the second current sensor 109b has occurred or the second current sensor 109b is being attached on not the interconnection point 103 of the W phase 101b but the electric wire of the reverse phase (for example, the interconnection point 103 of the U phase 101a). Therefore, the operation controller 112 stores in the embedded non-volatile memory (storage portion) the abnormal information indicating that the second current sensor 109b is abnormal (Step S219) and proceeds to Step S222.

In contrast, in a case where ΔI4 is outside the predetermined range (No in Step S218) and the amount of change in the current value of the second current sensor 109b is smaller than a predetermined value (in the present embodiment, smaller than −1 A) (Yes in Step S220), the operation controller 112 can determine that the attached position of the second current sensor 109b is proper (the second current sensor 109b is being attached to the interconnection point 103 of the W phase 101b) but the attached direction thereof is opposite. Therefore, the operation controller 112 reverses the positive and negative of the attached direction of the second current sensor 109b and stores this information in the embedded non-volatile memory. After this, the operation controller 112 corrects the sign of the current value detected by the second current sensor 109b by reversing the sign (Step S221). Then, the operation controller 112 proceeds to Step S222.

In Step S222, the operation controller 112 determines whether or not the amount of change (ΔI3) in the current value detected by the first current sensor 109a is outside the predetermined range (in Embodiment 1, a range from −1 A to 1 A).

Here, as described above, if the first current sensor 109a is being mistakenly attached to the interconnection point 103 of the W phase 101b, the current value of the first current sensor 109a changes so as to correspond to the amount of electric power consumed by the internal electric power load 111 when the second connector 110b has been turned on and off.

Therefore, in a case where the amount of change (413) in the current value of the first current sensor 109a is outside the predetermined range (Yes in Step S222), the operation controller 112 can determine that the first current sensor 109a is being mistakenly attached to the interconnection point 103 of the W phase 101b. On this account, the operation controller 112 stores in the embedded memory the abnormal information indicating that the first current sensor 109a is abnormal (Step S223) and proceeds to Step S224.

In contrast, in a case where ΔI3 is within the predetermined range (No in Step 222), the operation controller 112 proceeds to Step S224.

In Step S224, the operation controller 112 determines whether or not the abnormal information is being stored in the embedded non-volatile memory. In a case where the abnormal information is being stored in the embedded non-volatile memory (Yes in Step S224), the operation controller 112 causes the display unit 114 to display the abnormal information (Step S225). In contrast, in a case where the abnormal information is not stored in the embedded non-volatile memory (No in Step S224), the operation controller 112 causes the display unit 114 to display the normal information (Step S226). Then, the operation controller 112 terminates this program.

After the operation of the attached state confirmation test, the installer or maintenance worker can determine based on the result displayed on the display unit 114 that the attached state confirmation test has been terminated. At this time, in a case where the result displayed on the display unit 114 is the abnormal information, an attached state correcting operation is performed based on the information. After the correcting operation is completed, the attached state confirmation tests of the first current sensor 109a and the second current sensor 109b are again performed. These operations are repeated until the normal attached states are confirmed.

Thus, the distributed power generation system 102 according to Embodiment 1 can determine, by a simple configuration, the electric wires on which the first current sensor 109a and the second current sensor 109b are respectively provided and the installing directions of the first current sensor 109a and the second current sensor 109b. Therefore, the installer or maintenance worker can provide the first current sensor 109a and the second current sensor 109b at appropriate positions.

In Embodiment 1, the attached states are confirmed by the operation of the installer or maintenance worker. However, the present embodiment is not limited to this. After the installation or maintenance, the attached states may be confirmed periodically, for example, when the change in the current value of each of the first current sensor 109a and the second current sensor 109b is small, such as when turning on the distributed power generation system 102 or before or after the electric power generation of the electric power generator 105. At this time, in a case where the attached state is abnormal, a warning may be given to a user by using the display unit 114. With this, errors of the attached positions of the first current sensor 109a and/or the second current sensor 109b, corrections of the attached directions, and failures, such as wire breaking and come-off from the attached position, can be detected after the installation or maintenance.

Moreover, in Embodiment 1, the operation controller 112 determines the attached states based on the amount of change in the current value detected by the first current sensor 109a or the second current sensor 109b when the first connector 110a or second connector 110b of the connection mechanism 110 has been turned on and off.

For example, in a case where the current value detected by each of the first current sensor 109a and the second current sensor 109b when each of the first connector 110a and the second connector 110b is in an off state is nearly zero, the operation controller 112 may determine the attached states based on not the amount of change in the current value but the current value detected when the first connector 110a or the second connector 110b has been turned on.

### Modification Example

Next, Modification Example of the distributed power generation system 102 according to Embodiment 1 will be explained. Since the distributed power generation system 102 of Modification Example is the same in configuration as the distributed power generation system 102 according to Embodiment 1, a detailed explanation thereof is omitted.

Installed State Confirmation Operation of Current Sensor

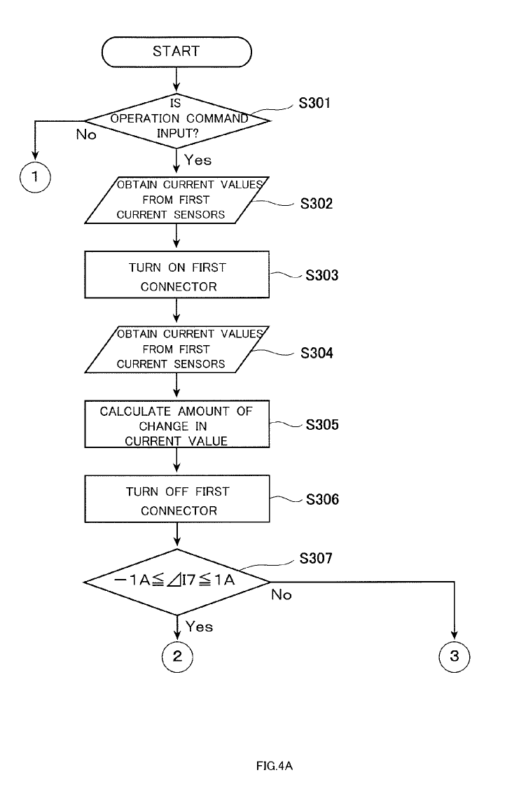

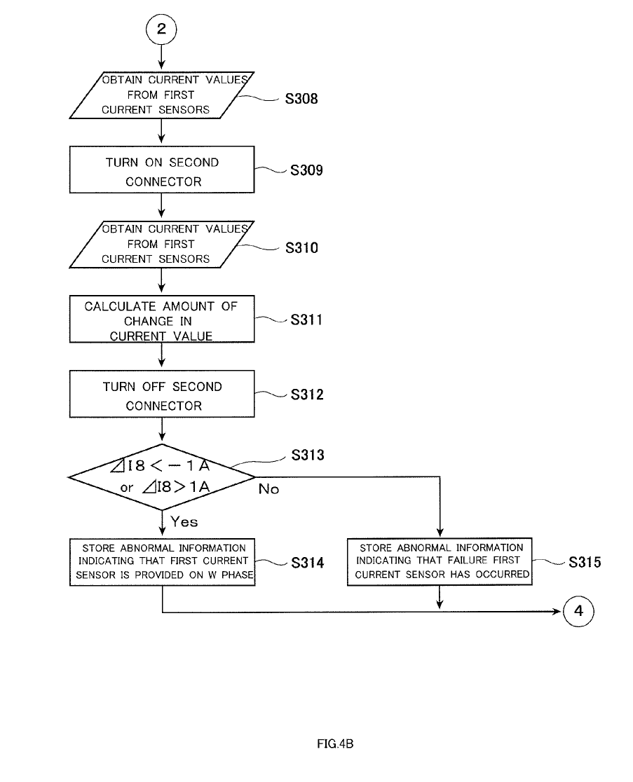

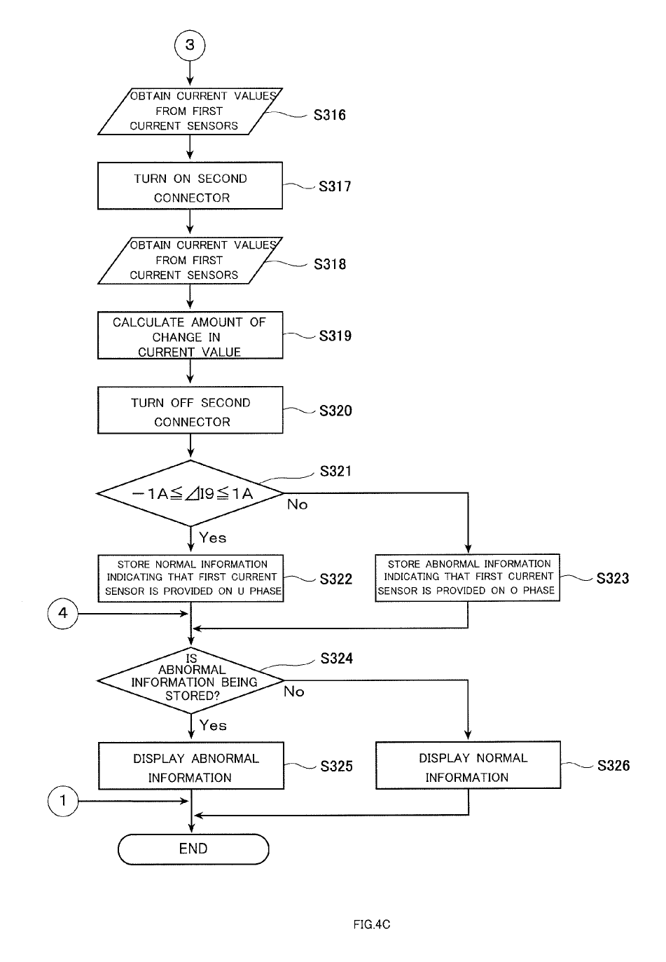

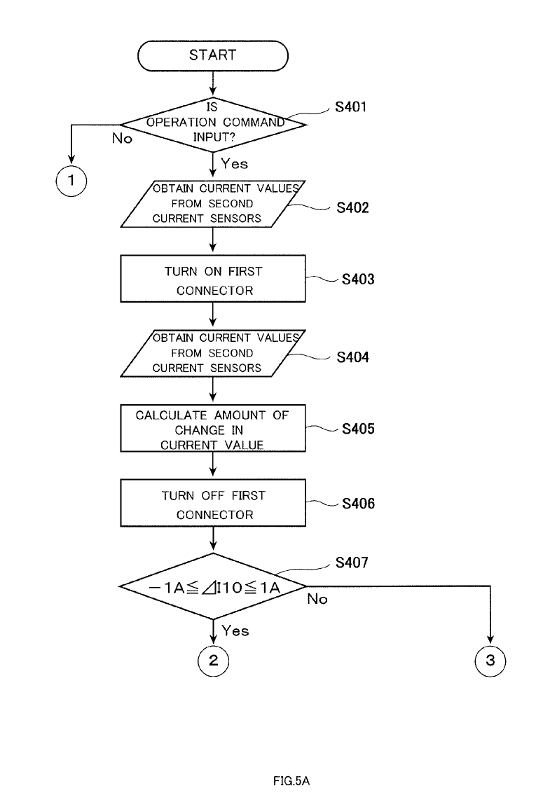

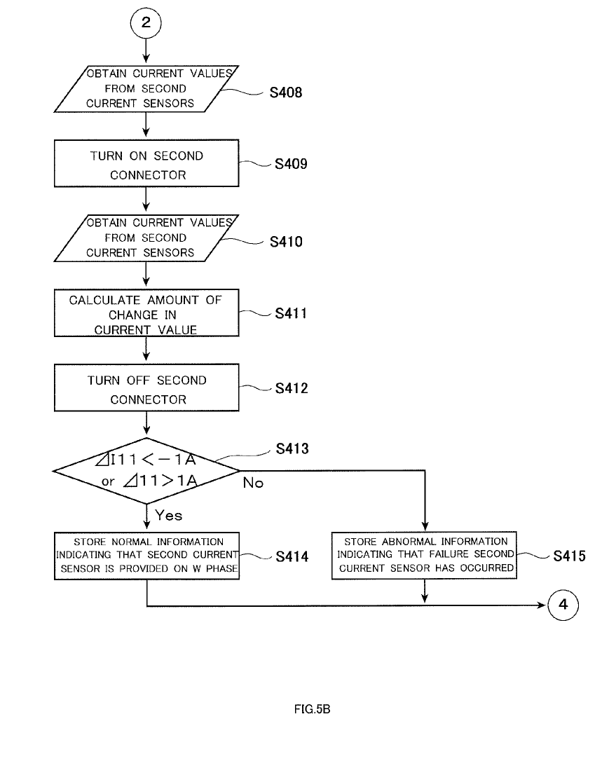

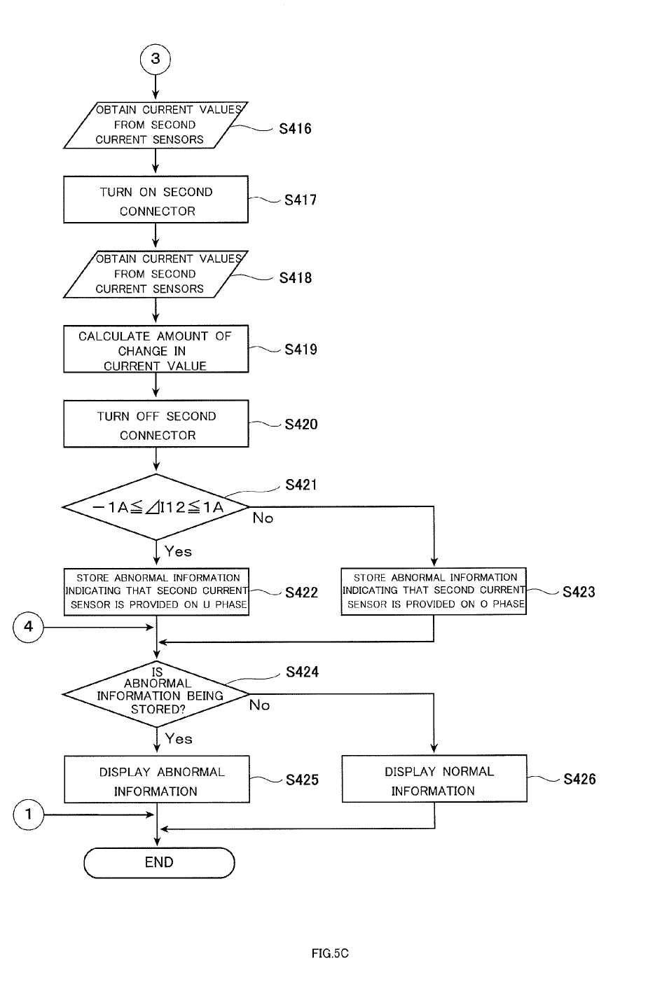

FIGS. 4A, 4B, and 4C are flow charts each schematically showing the installed state confirmation operation of the first current sensor in the distributed power generation system of Modification Example 1. FIGS. 5A, 5B, and 5C are flow charts each schematically showing the installed state confirmation operation of the second current sensor in the distributed power generation system of Modification Example 1.

Installed State Confirmation Operation of First Current Sensor

First, the installed state confirmation operation of the first current sensor 109a will be explained in reference to FIGS. 1, 4A, 4B, and 4C.

As shown in FIGS. 4A, 4B, and 4C, when the operation controller 112 receives the operation signal from the operating unit 113, the operation controller 112 starts the confirmation test (Yes in Step S301). Specifically, the operation controller 112 obtains the current value detected by the first current sensor 109a (Step S302).

Next, the operation controller 112 outputs to the connection mechanism 110 the command for turning on the first connector 110a (Step S303). With this, since the first connector 110a connects the internal electric power load 111 to the U phase 101a and the O phase 101c, the current flows through the interconnection point 103 of the U phase 101a.

At this time, the operation controller 112 again obtains the current value detected by the first current sensor 109a (Step S304) and calculates the amount of change in the current value from the current value obtained in Step S302 (in Modification Example, the amount of change in the current value in the first current sensor 109a from Step S302 is represented by ΔI7) (Step S305).

Next, the operation controller 112 outputs to the connection mechanism 110 the command for turning off the first connector 110a (Step S306). With this, since the first connector 110a cancels the connection between the internal electric power load 111 and each of the U phase 101a and the O phase 101c, the current does not flow through the interconnection point 103 of the U phase 101a.

Here, in a case where the current value detected by the first current sensor 109a has not changed so as to correspond to the amount of electric power consumed by the internal electric power load 111 when the first connector 110a has been turned on and off, to be specific, in a case where ΔI7 is within the predetermined range (in Modification Example, a range from −1 A to 1 A) (Yes in Step S307), the operation controller 112 proceeds to Step S308. In contrast, in a case where ΔI7 is outside the predetermined range (No in Step S307), the operation controller 112 proceeds to Step S316.

In Step S308, the operation controller 112 obtains the current value detected by the first current sensor 109a. Next, the operation controller 112 outputs to the connection mechanism 110 the command for turning on the second connector 110b (Step S309). With this, since the second connector 110b connects the internal electric power load 111 to the W phase 101b and the O phase 101c, the current flows through the interconnection point 103 of the W phase 101b.

At this time, the operation controller 112 again obtains the current value detected by the first current sensor 109a (Step S310) and calculates the amount of change in the current value from the current value obtained in Step S308 (in Modification Example, the amount of change in the current value in the first current sensor 109a from Step S308 is represented by ΔI8) (Step S311).

Next, the operation controller 112 outputs to the connection mechanism 110 the command for turning off the second connector 110b (Step S312). With this, since the second connector 110b cancels the connection between the internal electric power load 111 and each of the W phase 101b and the O phase 101c, the current does not flow through the interconnection point 103 of the W phase 101b.

Here, in a case where the current value detected by the first current sensor 109a has changed so as to correspond to the amount of electric power consumed by the internal electric power load 111 when the second connector 110b has been turned on and off, to be specific, ΔI8 is outside the predetermined range (in Modification Example, a range from −1 A to 1 A) (Yes in Step S313), the operation controller 112 can determine that the first current sensor 109a is being mistakenly provided on the W phase 101b. To be specific, in a case where the amount of change in the current value detected by the first current sensor 109a before and after the first connector 110a is turned on or off is within the predetermined range (Yes in Step S307) and the amount of change in the current value detected by the first current sensor 109a before and after the second connector 110b is turned on or off is outside the predetermined range (Yes in Step S313), the operation controller 112 can determine that the first current sensor 109a is being attached to the interconnection point 103 of the W phase 101b.

In contrast, in a case where the current value detected by the first current sensor 109a has not changed so as to correspond to the amount of electric power consumed by the internal electric power load 111 when the second connector 110b has been turned on and off, to be specific, in a case where ΔI8 is within the predetermined range (in Modification Example, a range from −1 A to 1 A) (No in Step S313), the operation controller 112 can determine that the failure of the first current sensor 109a is occurring. To be specific, in a case where the amount of change in the current value detected by the first current sensor 109a before and after the first connector 110a is turned on or off is within the predetermined range (Yes in Step S307) and the amount of change in the current value detected by the first current sensor 109a before and after the second connector 110b is turned on or off is within the predetermined range (No in Step S313), the first current sensor 109a is not detecting the current value. Therefore, the operation controller 112 can determine that the failure of the first current sensor 109a is occurring.

Therefore, in a case where ΔI8 is outside the predetermined range (Yes in Step S313), the operation controller 112 stores in the embedded non-volatile memory (storage portion) the abnormal information indicating that the first current sensor 109a is being provided on the W phase 101b (Step S314) and proceeds to Step S324. In contrast, in a case where ΔI8 is within the predetermined range (No in Step S313), the operation controller 112 stores in the storage portion the abnormal information indicating that the failure of the first current sensor 109a has occurred (Step S315) and proceeds to Step S324.

In contrast, as described above, in a case where ΔI7 is outside the predetermined range (No in Step S307), the operation controller 112 proceeds to Step S316. In Step S316, the operation controller 112 obtains the current value detected by the second current sensor 109b. Next, the operation controller 112 outputs to the connection mechanism 110 the command for turning on the second connector 110b (Step S317). With this, since the second connector 110b connects the internal electric power load 111 to the W phase 101b and the O phase 101c, the current flows through the interconnection point 103 of the W phase 101b.

At this time, the operation controller 112 again obtains the current value detected by the second current sensor 109b (Step S318) and calculates the amount of change in the current value from the current value obtained in Step S316 (in Modification Example, the amount of change in the current value in the second current sensor 109b from Step S316 is represented by ΔI9) (Step S319).

Next, the operation controller 112 outputs to the connection mechanism 110 the command for turning off the second connector 110b (Step S320). With this, since the second connector 110b cancels the connection between the internal electric power load 111 and each of the W phase 101b and the O phase 101c, the current does not flow through the interconnection point 103 of the W phase 101b.

Here, in a case where the current value detected by the second current sensor 109b has not changed so as to correspond to the amount of electric power consumed by the internal electric power load 111 when the second connector 110b has been turned on and off, to be specific, in a case where ΔI9 is within the predetermined range (in Modification Example, a range from −1 A to 1 A) (Yes in Step S321), the operation controller 112 can determine that the first current sensor 109a is being properly attached to the interconnection point 103 of the U phase 101a. To be specific, in a case where the amount of change in the current value detected by the first current sensor 109a before and after the first connector 110a is turned on or off is outside the predetermined range (No in Step S307) and the amount of change in the current value detected by the first current sensor 109a before and after the second connector 110b is turned on or off is within the predetermined range (Yes in Step S321), the operation controller 112 can determine that the first current sensor 109a is being attached to the interconnection point 103 of the U phase 101a.

In contrast, in a case where the current value detected by the second current sensor 109b has changed so as to correspond to the amount of electric power consumed by the internal electric power load 111 when the second connector 110b has been turned on and off, to be specific, ΔI9 is outside the predetermined range (in Modification Example, a range from −1 A to 1 A) (No in Step S321), the operation controller 112 can determine that the first current sensor 109a is being mistakenly attached to the interconnection point 103 of the O phase 101c. To be specific, in a case where the amount of change in the current value detected by the first current sensor 109a before and after the first connector 110a is turned on or off is outside the predetermined range (No in Step S307) and the amount of change in the current value detected by the first current sensor 109a before and after the second connector 110b is turned on or off is outside the predetermined range (No in Step S321), the operation controller 112 can determine that the first current sensor 109a is being attached to the interconnection point 103 of the O phase 101c.

Therefore, in a case where ΔI9 is within the predetermined range (Yes in Step S321), the operation controller 112 stores in the embedded non-volatile memory (storage portion) the normal information indicating that the first current sensor 109a is being provided on the U phase 101a (Step S322) and proceeds to Step S324. In contrast, in a case where ΔI9 is outside the predetermined range (No in Step S321), the operation controller 112 stores in the storage portion the abnormal information indicating that the first current sensor 109a is being mistakenly provided on the O phase 101c (Step S323) and proceeds to Step S324.

In Step S324, the operation controller 112 determines whether or not the abnormal information is being stored in the embedded non-volatile memory. In a case where the abnormal information is being stored in the embedded non-volatile memory (Yes in Step S324), the operation controller 112 causes the display unit 114 to display the abnormal information (Step S325). In contrast, in a case where the abnormal information is not stored in the embedded non-volatile memory (No in Step S324), the operation controller 112 causes the display unit 114 to display the normal information (Step S326). Then, the operation controller 112 terminates this program.

Thus, the distributed power generation system 102 of Modification Example 1 can confirm the installed state of the first current sensor 109a.

Installed State Confirmation Operation of Second Current Sensor

Next, the installed state confirmation operation of the second current sensor 109b will be explained in reference to FIGS. 1, 5A, 5B, and 5C.

As shown in FIGS. 5A, 5B, and 5C, when the operation controller 112 receives the operation signal from the operating unit 113, the operation controller 112 starts the confirmation test (Yes in Step S401). Specifically, the operation controller 112 obtains the current value detected by the second current sensor 109b (Step S402).

Next, the operation controller 112 outputs to the connection mechanism 110 the command for turning on the first connector 110a (Step S403). With this, since the first connector 110a connects the internal electric power load 111 to the U phase 101a and the O phase 101c, the current flows through the interconnection point 103 of the U phase 101a.

At this time, the operation controller 112 again obtains the current value detected by the second current sensor 109b (Step S404) and calculates the amount of change in the current value from the current value obtained in Step S402 (in the present embodiment, the amount of change in the current value in the second current sensor 109b from Step S402 is represented by ΔI10) (Step S405).

Next, the operation controller 112 outputs to the connection mechanism 110 the command for turning off the first connector 110a (Step S406). With this, since the first connector 110a cancels the connection between the internal electric power load 111 and each of the U phase 101a and the O phase 101c, the current does not flow through the interconnection point 103 of the U phase 101a.

Here, in a case where the current value detected by the second current sensor 109b has not changed so as to correspond to the amount of electric power consumed by the internal electric power load 111 when the first connector 110a has been turned on and off, to be specific, in a case where ΔI10 is within the predetermined range (in Modification Example, a range from −1 A to 1 A) (Yes in Step S407), the operation controller 112 proceeds to Step S408. In contrast, in a case where ΔI10 is outside the predetermined range (No in Step S407), the operation controller 112 proceeds to Step S416.

In Step S408, the operation controller 112 obtains the current value detected by the second current sensor 109b. Next, the operation controller 112 outputs to the connection mechanism 110 the command for turning on the second connector 110b (Step S409). With this, since the second connector 110b connects the internal electric power load 111 to the W phase 101b and the O phase 101c, the current flows through the interconnection point 103 of the W phase 101b.

At this time, the operation controller 112 again obtains the current value detected by the second current sensor 109b (Step S410) and calculates the amount of change in the current value from the current value obtained in Step S408 (in Modification Example, the amount of change in the current value in the second current sensor 109b from Step S408 is represented by ΔI11) (Step S411).

Next, the operation controller 112 outputs to the connection mechanism 110 the command for turning off the second connector 110b (Step S412). With this, since the second connector 110b cancels the connection between the internal electric power load 111 and each of the W phase 101b and the O phase 101c, the current does not flow through the interconnection point 103 of the W phase 101b.

Here, in a case where the current value detected by the second current sensor 109b has changed so as to correspond to the amount of electric power consumed by the internal electric power load 111 when the second connector 110b has been turned on and off, to be specific, in a case where ΔI11 is outside the predetermined range (in Modification Example, a range from −1 A to 1 A) (Yes in Step S413), the operation controller 112 can determine that the second current sensor 109b is being properly provided on the W phase 101b. To be specific, in a case where the amount of change in the current value detected by the second current sensor 109b before and after the first connector 110a is turned on or off is within the predetermined range (Yes in Step S407) and the amount of change in the current value detected by the second current sensor 109b before and after the second connector 110b is turned on or off is outside the predetermined range (Yes in Step S413), the operation controller 112 can determine that the second current sensor 109b is being attached to the interconnection point 103 of the W phase 101b.

In contrast, in a case where the current value detected by the second current sensor 109b has not changed so as to correspond to the amount of electric power consumed by the internal electric power load 111 when the second connector 110b has been turned on and off, to be specific, in a case where ΔI11 is within the predetermined range (in Modification Example, a range from −1 A to 1 A) (No in Step S413), the operation controller can determine that the failure of the second current sensor 109b is occurring. To be specific, in a case where the amount of change in the current value detected by the second current sensor 109b before and after the first connector 110a is turned on or off is within the predetermined range (Yes in Step S407) and the amount of change in the current value detected by the second current sensor 109b before and after the second connector 110b is turned on or off is within the predetermined range (No in Step S413), the second current sensor 109b is not detecting the current value. Therefore, the operation controller 112 can determine that the failure of the second current sensor 109b is occurring.

On this account, in a case where ΔI11 is outside the predetermined range (Yes in Step S413), the operation controller 112 stores in the embedded non-volatile memory (storage portion) the normal information indicating that the second current sensor 109b is being provided on the W phase 101b (Step S414) and proceeds to Step S424. In contrast, in a case where ΔI11 is within the predetermined range (No in Step S413), the operation controller 112 stores in the storage portion the abnormal information indicating that the failure of the second current sensor 109b has occurred (Step S415) and proceeds to Step S424.

In contrast, as described above, in a case where ΔI10 is outside the predetermined range (No in Step S407), the operation controller 112 proceeds to Step S416. In Step S416, the operation controller 112 obtains the current value detected by the second current sensor 109b. Next, the operation controller 112 outputs to the connection mechanism 110 the command for turning on the second connector 110b (Step S417). With this, since the second connector 110b connects the internal electric power load 111 to the W phase 101b and the O phase 101c, the current flows through the interconnection point 103 of the W phase 101b.

At this time, the operation controller 112 again obtains the current value detected by the second current sensor 109b (Step S418) and calculates the amount of change in the current value from the current value obtained in Step S416 (in Modification Example, the amount of change in the current value in the second current sensor 109b from Step S416 is represented by ΔI12) (Step S419).

Next, the operation controller 112 outputs to the connection mechanism 110 the command for turning off the second connector 110b (Step S420). With this, since the second connector 110b cancels the connection between the internal electric power load 111 and each of the W phase 101b and the O phase 101c, the current does not flow through the interconnection point 103 of the W phase 101b.

Here, in a case where the current value detected by the second current sensor 109b has not changed so as to correspond to the amount of electric power consumed by the internal electric power load 111 when the second connector 110b has been turned on and off, to be specific, in a case where ΔI12 is within the predetermined range (in Modification Example, a range from −1 A to 1 A) (Yes in Step S421), the operation controller 112 can determine that the second current sensor 109b is being mistakenly attached to the interconnection point 103 of the U phase 101a. To be specific, in a case where the amount of change in the current value detected by the second current sensor 109b before and after the first connector 110a is turned on or off is outside the predetermined range (No in Step S407) and the amount of change in the current value detected by the second current sensor 109b before and after the second connector 110b is turned on or off is within the predetermined range (Yes in Step S421), the operation controller 112 can determine that the second current sensor 109b is being attached to the interconnection point 103 of the U phase 101a.

In contrast, in a case where the current value detected by the second current sensor 109b has changed so as to correspond to the amount of electric power consumed by the internal electric power load 111 when the second connector 110b has been turned on and off, to be specific, in a case where ΔI12 is outside the predetermined range (in Modification Example, a range from −1 A to 1 A) (No in Step S421), the operation controller 112 can determine that the second current sensor 109b is being mistakenly attached to the interconnection point 103 of the O phase 101c. To be specific, in a case where the amount of change in the current value detected by the second current sensor 109b before and after the first connector 110a is turned on or off is outside the predetermined range (No in Step S407) and the amount of change in the current value detected by the second current sensor 109b before and after the second connector 110b is turned on or off is outside the predetermined range (No in Step S421), the operation controller 112 can determine that the second current sensor 109b is being attached to the interconnection point 103 of the O phase 101c.

Therefore, in a case where ΔI12 is within the predetermined range (Yes in Step S421), the operation controller 112 stores in the embedded non-volatile memory (storage portion) the abnormal information indicating that the second current sensor 109b is being mistakenly provided on the U phase 101a (Step S422) and proceeds to Step S424. In contrast, in a case where ΔI12 is outside the predetermined range (No in Step S421), the operation controller 112 stores in the storage portion the abnormal information indicating that the second current sensor 109b is being mistakenly provided on the O phase 101c (Step S423) and proceeds to Step S424.

In Step S424, the operation controller 112 determines whether or not the abnormal information is being stored in the embedded non-volatile memory. In a case where the abnormal information is being stored in the embedded non-volatile memory (Yes in Step S424), the operation controller 112 causes the display unit 114 to display the abnormal information (Step S425). In contrast, in case where the abnormal information is not stored in the embedded non-volatile memory (No in Step S424), the operation controller 112 causes the display unit 114 to display the normal information (Step S426). Then, the operation controller 112 terminates this program.

Thus, the distributed power generation system 102 of Modification Example 1 can confirm the installed state of the second current sensor 109b.

The distributed power generation system 102 of Modification Example 1 configured as above also has the same operational advantages as the distributed power generation system 102 according to Embodiment 1. In addition, the distributed power generation system 102 of Modification Example 1 can more specifically determine the electric wires on which the first current sensor 109a and the second current sensor 109b are respectively provided.

In Modification Example 1, the flows of determining the installing directions of the first current sensor 109a and the second current sensor 109b are not described. However, the installing directions of the first current sensor 109a and the second current sensor 109b can be easily determined in reference to the flows described in Embodiment 1. In addition, the distributed power generation system 102 of Modification Example 1 may be configured such that in a case where the installing directions of the first current sensor 109a and/or the second current sensor 109b are the reverse directions, the operation controller 112 reverses the positive and negative of each of the attached directions of the first current sensor 109a and/or the second current sensor 109b and stores this information in the storage portion, and after this, the signs of the current values detected by the first current sensor 109a and/or the second current sensor 109b are corrected by reversing the signs.

### Embodiment 2

In the distributed power generation system according to Embodiment 2 of the present invention, the connection mechanism includes a third connector configured to connect the first electric wire and the second electric wire to the internal electric power load, and the controller is configured to determine that the first current sensor is provided on the third electric wire or the first current sensor itself is abnormal in a case where the amount of change in the current value detected by the first current sensor before and after the third connector connects the first electric wire and the second electric wire to the internal electric power load is not the amount corresponding to the power consumption of the internal electric power load.

Configuration of Distributed Power Generation System

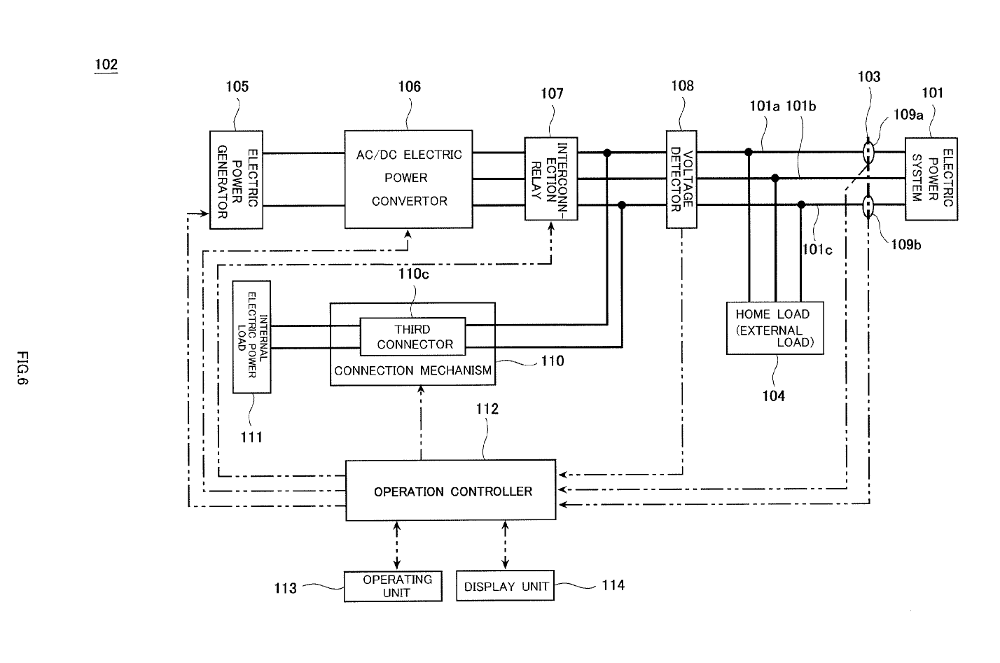

FIG. 6 is a block diagram schematically showing the schematic configuration of the distributed power generation system according to Embodiment 2 of the present invention.

As shown in FIG. 6, the distributed power generation system 102 according to Embodiment 2 of the present invention is the same in basic configuration as the distributed power generation system 102 according to Embodiment 1 but is different from the distributed power generation system 102 according to Embodiment 1 in that the connection mechanism 110 is constituted by a third connector 110c. Specifically, the third connector 110c is configured to connect the internal electric power load 111 to the U phase 101a and the W phase 101b in the electric power system 101 when the third connector 110c is in an on state.

Operations of Distributed Power Generation System (Installed State Confirmation Operation of Current Sensor)

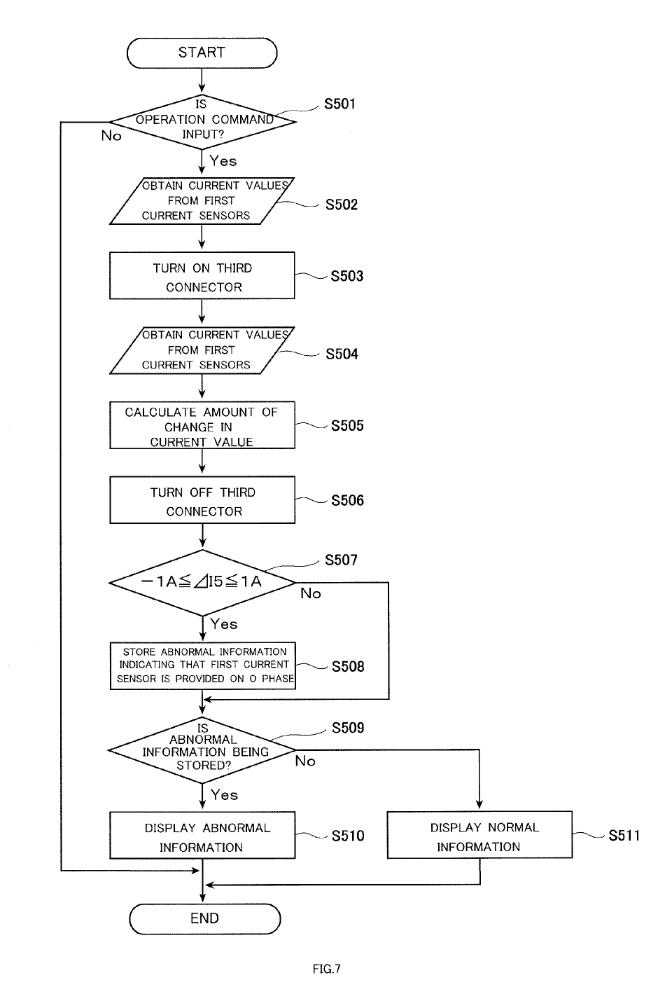

Next, the operations of the distributed power generation system 102 according to Embodiment 2 (the installed state confirmation operation of the current sensor) will be explained in reference to FIGS. 6 and 7.

FIG. 7 is a flow chart schematically showing the installed state confirmation operation of the first current sensor in the distributed power generation system according to Embodiment 2 of the present invention.

As shown in FIG. 7, when the operation controller 112 receives the operation signal from the operating unit 113, the operation controller 112 starts the confirmation test (Yes in Step S501). Specifically, the operation controller 112 obtains the current value detected by the first current sensor 109a (Step S502).

Next, the operation controller 112 outputs to the connection mechanism 110 a command for turning on the third connector 110c (Step S503). With this, since the third connector 110c connects the internal electric power load 111 to the U phase 101a and the W phase 101b, the current flows through the interconnection point 103 of the U phase 101a and the interconnection point 103 of the W phase 101b.

At this time, the operation controller 112 again obtains the current value detected by the first current sensor 109a (Step S504) and calculates the amount of change in the current value from the current value obtained in Step S502 (in Embodiment 2, the amount of change in the current value in the first current sensor 109a from Step S502 is represented by ΔI5) (Step S505).

Next, the operation controller 112 outputs to the connection mechanism 110 a command for turning off the third connector 110c (Step S506). With this, since the third connector 110c cancels the connection between the internal electric power load 111 and each of the U phase 101a and the W phase 101b, the current does not flow through the interconnection point 103 of the U phase 101a and the interconnection point 103 of the W phase 101b.

Here, in a case where the current value detected by the first current sensor 109a has not changed so as to correspond to the amount of electric power consumed by the internal electric power load 111 when the third connector 110c has been turned on and off, to be specific, in a case where ΔI5 is within the predetermined range (in Embodiment 2, a range from −1 A to 1 A) (Yes in Step S507), the operation controller 112 can determine that the first current sensor 109a is being mistakenly attached to the interconnection point 103 of the O phase 101c or the first current sensor 109a itself is abnormal.

Therefore, in a case where ΔI5 is within the predetermined range (Yes in Step S507), the operation controller 112 stores in the embedded non-volatile memory (storage portion) the abnormal information indicating that the first current sensor 109a is being provided on the O phase 101c (Step S508) and proceeds to Step S509. In contrast, in a case where ΔI5 is outside the predetermined range (No in Step S507), the operation controller 112 proceeds to Step S509.

In Step S509, the operation controller 112 determines whether or not the abnormal information is being stored in the embedded non-volatile memory. In a case where the abnormal information is being stored in the embedded non-volatile memory (Yes in Step S509), the operation controller 112 causes the display unit 114 to display the abnormal information (Step S510). In contrast, in a case where the abnormal information is not stored in the embedded non-volatile memory (No in Step S509), the operation controller 112 causes the display unit 114 to display the normal information (Step S511). Then, the operation controller 112 terminates this program.

Thus, the distributed power generation system 102 according to Embodiment 2 can confirm the installed state of the first current sensor 109a. Specifically, the distributed power generation system 102 according to Embodiment 2 can confirm that the first current sensor 109a is not being provided on the interconnection point 103 of the O phase 101c.

### Modification Example

Next, Modification Example of the distributed power generation system 102 according to Embodiment 2 will be explained.

In the distributed power generation system of Modification Example of Embodiment 2, the connection mechanism includes a third connector configured to connect the first electric wire and the second electric wire to the internal electric power load, and the controller is configured to determine that the second current sensor is provided on the third electric wire or the second current sensor itself is abnormal in a case where the amount of change in the current value detected by the second current sensor before and after the third connector connects the first electric wire and the second electric wire to the internal electric power load is not the amount corresponding to the power consumption of the internal electric power load.

Operations of Distributed Power Generation System (Installed State Confirmation Operation of Current Sensor)

Since the distributed power generation system of Modification Example is the same in basic configuration as the distributed power generation system according to Embodiment 2, a detailed explanation thereof is omitted.

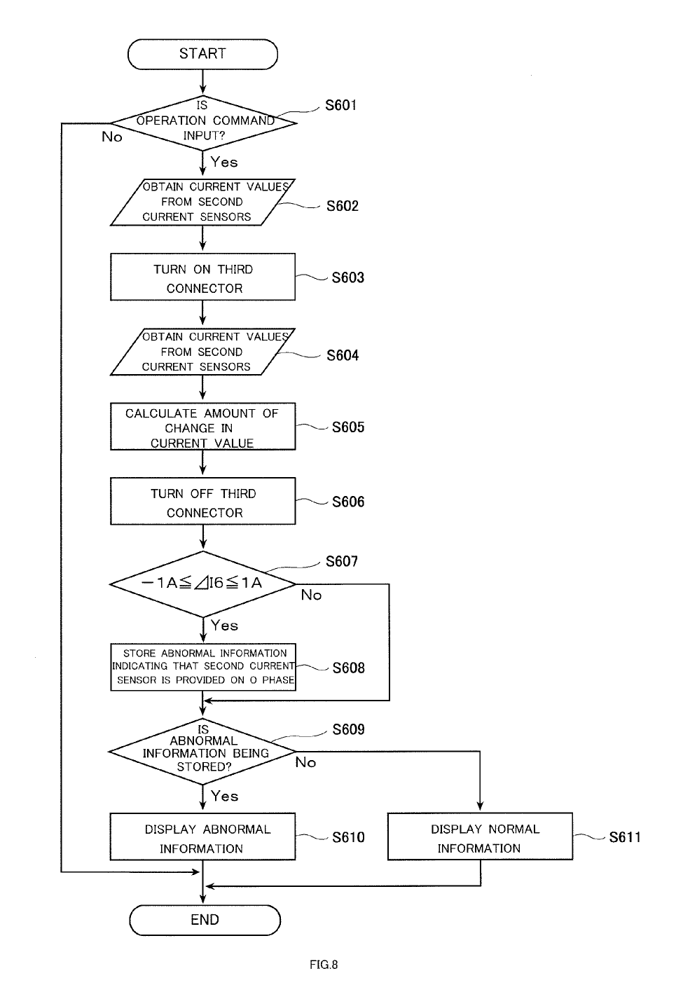

FIG. 8 is a flow chart schematically showing the installed state confirmation operation of the second current sensor in the distributed power generation system of Modification Example of Embodiment 2.

As shown in FIG. 8, when the operation controller 112 receives the operation signal from the operating unit 113, the operation controller 112 starts the confirmation test (Yes in Step S601). Specifically, the operation controller 112 obtains the current value detected by the second current sensor 109b (Step S602).

Next, the operation controller 112 outputs to the connection mechanism 110 the command for turning on the third connector 110c (Step S603). With this, since the third connector 110c connects the internal electric power load 111 to the U phase 101a and the W phase 101b, the current flows through the interconnection point 103 of the U phase 101a and the interconnection point 103 of the W phase 101b.

At this time, the operation controller 112 again obtains the current value detected by the second current sensor 109b (Step S604) and calculates the amount of change in the current value from the current value obtained in Step S602 (in Modification Example, the amount of change in the current value in the second current sensor 109b from Step S602 is represented by ΔI6) (Step S605).

Next, the operation controller 112 outputs to the connection mechanism 110 the command for turning off the third connector 110c (Step S606). With this, since the third connector 110c cancels the connection between the internal electric power load 111 and each of the U phase 101a and the W phase 101b, the current does not flow through the interconnection point 103 of the U phase 101a and the interconnection point 103 of the W phase 101b.

Here, in a case where the current value detected by the second current sensor 109b has not changed so as to correspond to the amount of electric power consumed by the internal electric power load 111 when the third connector 110c has been turned on and off, to be specific, in a case where ΔI6 is within the predetermined range (in Modification Example, a range from −1 A to 1 A) (Yes in Step S607), the operation controller 112 can determine that the second current sensor 109b is being mistakenly attached to the interconnection point 103 of the O phase 101c or the second current sensor 109b itself is abnormal.

Therefore, in a case where ΔI6 is within the predetermined range (Yes in Step S607), the operation controller 112 stores in the embedded non-volatile memory (storage portion) the abnormal information indicating that the first current sensor 109a is being provided on the O phase 101c (Step S608) and proceeds to Step S609. In contrast, in a case where ΔI6 is outside the predetermined range (No in Step S607), the operation controller 112 proceeds to Step S609.

In Step S609, the operation controller 112 determines whether or not the abnormal information is being stored in the embedded non-volatile memory. In a case where the abnormal information is being stored in the embedded non-volatile memory (Yes in Step S609), the operation controller 112 causes the display unit 114 to display the abnormal information (Step S610). In contrast, in a case where the abnormal information is not stored in the embedded non-volatile memory (No in Step S609), the operation controller 112 causes the display unit 114 to display the normal information (Step S611). Then, the operation controller 112 terminates this program.

Thus, the distributed power generation system 102 of Modification Example can confirm the installed state of the second current sensor 109b. Specifically, the distributed power generation system 102 of Modification Example can confirm that the second current sensor 109b is not being provided on the interconnection point 103 of the O phase 101c.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the spirit of the present invention. In addition, various inventions can be made by suitable combinations of a plurality of components disclosed in the above embodiments.

### INDUSTRIAL APPLICABILITY

The distributed power generation system of the present invention is useful since it can determine, by a simple configuration, the electric wire on which the current sensor is provided and the installing direction of the current sensor.

### REFERENCE SIGNS LIST

1 private electric power generator
2 distribution board
3 commercial electric power system
4 branch disconnector
7 calculation storage portion
8a electric power calculating portion
8b electric power calculating portion
10 display unit
14 addition calculating portion
15 non-volatile memory
16 sign determining portion
101 electric power system
101a U phase (first electric wire)
101b W phase (second electric wire)
101c O phase (third electric wire)
102 distributed power generation system
103 interconnection point
104 home load (external electric power load)
105 electric power generator
106 AC/DC electric power converter
107 interconnection relay
108 voltage detector
109a first current sensor
109b second current sensor
110 connection mechanism
110a first connector
110b second connector
110c third connector
111 internal electric power load
112 operation controller (controller)
113 operating unit
114 display unit

1. A distributed power generation system connected to a three-wire electric power system including first to third electric wires, the third electric wire being a neutral wire,
the distributed power generation system comprising:
an electric power generator;
a connection mechanism configured to connect any two electric wires among the first to third electric wires to an internal electric power load;
a first current sensor set so as to detect a current value of the first electric wire;
a second current sensor set so as to detect a current value of the second electric wire; and
a controller configured to determine the electric wire on which each of the first current sensor and the second current sensor is provided among the first to third electric wires and an installing direction of each of the first current sensor and the second current sensor by determining whether or not an amount of change in the current value detected by each of the first current sensor and the second current sensor before and after the connection mechanism connects said any two electric wires to the internal electric power load is an amount corresponding to power consumption of the internal electric power load, wherein:
the connection mechanism includes a first connector configured to connect the first electric wire and the third electric wire to the internal electric power load and a second connector configured to connect the second electric wire and the third electric wire to the internal electric power load; and
the controller is configured to determine that the first current sensor is provided on the third electric wire in a case where each of both the amount of change in the current value detected by the first current sensor before and after the first connector connects the first electric wire and the third electric wire to the internal electric power load and the amount of change in the current value detected by the first current sensor before and after the second connector connects the second electric wire and the third electric wire to the internal electric power load is the amount corresponding to the power consumption of the electric power load.

2. (canceled)

3. The distributed power generation system according to claim 1, wherein the controller is configured to determine that the first current sensor is provided on the first electric wire in a case where the amount of change in the current value detected by the first current sensor before and after the first connector connects the first electric wire and the third electric wire to the internal electric power load is the amount corresponding to the power consumption of the electric power load and the amount of change in the current value detected by the first current sensor before and after the second connector connects the second electric wire and the third electric wire to the internal electric power load is not the amount corresponding to the power consumption of the electric power load.

4. The distributed power generation system according to claim 3, wherein:
the controller is configured to determine that the first current sensor is provided on the first electric wire in a right direction in a case where the amount of change in the current value detected by the first current sensor before and after the first connector connects the first electric wire and the third electric wire to the internal electric power load is the amount corresponding to the power consumption of the electric power load and is positive; and
the controller is configured to determine that the first current sensor is provided on the first electric wire in a reverse direction in a case where the amount of change in the current value detected by the first current sensor before and after the first connector connects the first electric wire and the third electric wire to the internal electric power load is the amount corresponding to the power consumption of the electric power load and is negative.

5. The distributed power generation system according to claim 1, wherein the controller is configured to determine that the first current sensor is provided on the second electric wire in a case where the amount of change in the current value detected by the first current sensor before and after the first connector connects the first electric wire and the third electric wire to the internal electric power load is not the amount corresponding to the power consumption of the electric power load and the amount of change in the current value detected by the first current sensor before and after the second connector connects the second electric wire and the third electric wire to the internal electric power load is the amount corresponding to the power consumption of the electric power load.

6. The distributed power generation system according to claim 5, wherein:
the controller is configured to determine that the first current sensor is provided on the second electric wire in a right direction in a case where the amount of change in the current value detected by the first current sensor before and after the second connector connects the second electric wire and the third electric wire to the internal electric power load is the amount corresponding to the power consumption of the electric power load and is positive; and
the controller is configured to determine that the first current sensor is provided on the second electric wire in a reverse direction in a case where the amount of change in the current value detected by the first current sensor before and after the second connector connects the second electric wire and the third electric wire to the internal electric power load is the amount corresponding to the power consumption of the electric power load and is negative.

7. (canceled)

8. The distributed power generation system according to claim 1, wherein the controller is configured to determine that the first current sensor is abnormal in a case where each of both the amount of change in the current value detected by the first current sensor before and after the first connector connects the first electric wire and the third electric wire to the internal electric power load and the amount of change in the current value detected by the first current sensor before and after the second connector connects the second electric wire and the third electric wire to the internal electric power load is not the amount corresponding to the power consumption of the electric power load.

9. The distributed power generation system according to claim 1, wherein the controller is configured to determine that the second current sensor is provided on the second electric wire in a case where the amount of change in the current value detected by the second current sensor before and after the first connector connects the first electric wire and the third electric wire to the internal electric power load is not the amount corresponding to the power consumption of the electric power load and the amount of change in the current value detected by the second current sensor before and after the second connector connects the second electric wire and the third electric wire to the internal electric power load is the amount corresponding to the power consumption of the electric power load.

10. The distributed power generation system according to claim 9, wherein:
the controller is configured to determine that the second current sensor is provided on the second electric wire in a right direction in a case where the amount of change in the current value detected by the second current sensor before and after the second connector connects the second electric wire and the third electric wire to the internal electric power load is the amount corresponding to the power consumption of the electric power load and is positive; and
the controller is configured to determine that the second current sensor is provided on the second electric wire in a reverse direction in a case where the amount of change in the current value detected by the second current sensor before and after the second connector connects the second electric wire and the third electric wire to the internal electric power load is the amount corresponding to the power consumption of the electric power load and is negative.

11. The distributed power generation system according to claim 1, wherein the controller is configured to determine that the second current sensor is provided on the first electric wire in a case where the amount of change in the current value detected by the second current sensor before and after the first connector connects the first electric wire and the third electric wire to the internal electric power load is the amount corresponding to the power consumption of the electric power load and the amount of change in the current value detected by the second current sensor before and after the second connector connects the second electric wire and the third electric wire to the internal electric power load is not the amount corresponding to the power consumption of the electric power load.

12. The distributed power generation system according to claim 11, wherein
the controller is configured to determine that the second current sensor is provided on the first electric wire in a right direction in a case where the amount of change in the current value detected by the second current sensor before and after the first connector connects the first electric wire and the third electric wire to the internal electric power load is the amount corresponding to the power consumption of the electric power load and is positive; and
the controller is configured to determine that the second current sensor is provided on the first electric wire in a reverse direction in a case where the amount of change in the current value detected by the second current sensor before and after the first connector connects the first electric wire and the third electric wire to the internal electric power load is the amount corresponding to the power consumption of the electric power load and is negative.

13. The distributed power generation system according to claim 1, wherein the controller is configured to determine that the second current sensor is provided on the third electric wire in a case where each of both the amount of change in the current value detected by the second current sensor before and after the first connector connects the first electric wire and the third electric wire to the internal electric power load and the amount of change in the current value detected by the second current sensor before and after the second connector connects the second electric wire and the third electric wire to the internal electric power load is the amount corresponding to the power consumption of the electric power load.

14. The distributed power generation system according to claim 1, wherein the controller is configured to determine that the second current sensor is abnormal in a case where each of both the amount of change in the current value detected by the second current sensor before and after the first connector connects the first electric wire and the third electric wire to the internal electric power load and the amount of change in the current value detected by the second current sensor before and after the second connector connects the second electric wire and the third electric wire to the internal electric power load is not the amount corresponding to the power consumption of the electric power load.

15. The distributed power generation system according to claim 1, wherein:
the connection mechanism includes a third connector configured to connect the first electric wire and the second electric wire to the internal electric power load; and
the controller is configured to determine that the first current sensor is provided on the third electric wire or the first current sensor itself is abnormal in a case where the amount of change in the current value detected by the first current sensor before and after the third connector connects the first electric wire and the second electric wire to the internal electric power load is not the amount corresponding to the power consumption of the internal electric power load.

16. The distributed power generation system according to claim 1, wherein:
the connection mechanism includes a third connector configured to connect the first electric wire and the second electric wire to the internal electric power load; and
the controller is configured to determine that the second current sensor is provided on the third electric wire or the second current sensor itself is abnormal in a case where the amount of change in the current value detected by the second current sensor before and after the third connector connects the first electric wire and the second electric wire to the internal electric power load is not the amount corresponding to the power consumption of the internal electric power load.

17. The distributed power generation system according to claim 1, further comprising an operating unit configured to operate the controller, wherein
the controller is configured to, by an operation command of the operating unit, start determining the electric wire on which each of the first current sensor and the second current sensor is provided and the installing direction of each of the first current sensor and the second current sensor.

18. The distributed power generation system according to claim 1, further comprising a display unit configured to display results of determinations of the first current sensor and the second current sensor by the controller.
